(19) United States
(12) Patent Application Publication
(10) Pub. No.: US 2023/0008711 A1
(43) Pub. Date: Jan. 12, 2023

(54) CATHODE, ELECTROCHEMICAL CELL COMPRISING CATHODE, AND METHOD OF PREPARING CATHODE

(71) Applicant: Samsung Electronics Co., Ltd., Suwon-si (KR)

(72) Inventors: Huisu Jeong, Seongnam-si (KR); Kyounghwan Kim, Seoul (KR); Joungwon Park, Seongnam-si (KR); Jeongkuk Shon, Seong-si (KR); Jinsuck Heo, Suwon-si (KR)

(21) Appl. No.: 17/856,119

(22) Filed: Jul. 1, 2022

(30) Foreign Application Priority Data
Jul. 2, 2021 (KR) 10-2021-0087431

(51) Int. Cl. H01M 4/36; H01M 10/052; H01M 4/525; H01M 4/505; H01M 4/485; H01M 4/1315; H01M 4/13915; H01M 4/04

(52) U.S. Cl. CPC H01M 4/366; H01M 10/052; H01M 4/525; H01M 4/505; H01M 4/485; H01M 4/1315; H01M 4/13915; H01M 4/0471; H01M 2004/021

(57) ABSTRACT

A cathode including: a cathode current collector; and a cathode active material layer disposed on the cathode current collector and including a first surface, and a second surface opposite the first surface and adjacent to the cathode current collector, wherein the cathode active material layer includes a cathode active material including a dopant, and wherein a concentration gradient of the dopant decreases in a direction from the first surface to the second surface.

### CROSS-REFERENCE TO RELATED APPLICATION

This application is based on and claims priority to Korean Patent Application No. 10-2021-0087431, filed on Jul. 2, 2021, in the Korean Intellectual Property Office, and all the benefits accruing therefrom under 35 U.S.C. § 119, the content of which in its entirety is herein incorporated by reference.

### BACKGROUND

### 1. Field

The present disclosure relates to a cathode, and an electrochemical cell including the cathode, and a method for preparing the cathode.

### 2. Description of the Related Art

With the development of technology in the electronics field, mobile phones, game consoles, portable multimedia player (“PMP”), mpeg audio layer-3 (“MP3”) players, as well as smartphones, smart pads, e-readers, tablet computers, and mobile medical devices attachable to the body, the market for various types of mobile electronic devices is significantly growing. As the market related to such mobile electronic devices grows, the demand for batteries suitable for driving mobile electronic devices is also increasing.

Unlike a primary battery that cannot be charged, a secondary battery is a battery that can be charged and discharged, and specifically, a lithium secondary battery has several advantages, including a higher voltage than a nickel-cadmium battery or a nickel-hydrogen battery, and a higher energy density.

There remains a need for improved battery materials.

### SUMMARY

An aspect is to provide a cathode having improved stability.

Another aspect is to provide an electrochemical cell having improved lifespan characteristics.

Another aspect is to provide a method for preparing a cathode having improved stability.

Additional aspects will be set forth in part in the description which follows and, in part, will be apparent from the description, or may be learned by practice of the presented embodiments of the disclosure.

According to an aspect, provided is a cathode including: a cathode current collector; and a cathode active material layer disposed on the cathode current collector and including a first surface, and a second surface opposite the first surface and adjacent to the cathode current collector, and the cathode active material layer includes a cathode active material including a dopant, having a concentration gradient in which the concentration of the dopant decreases in a direction from the first surface to the second surface.

According to another aspect, provided is an electrochemical cell including: the cathode; an anode; a separator disposed between the cathode and the anode; and an electrolyte in a pore of the separator.

According to another aspect, provided is an electrochemical cell including: the cathode; an anode; and a solid-state electrolyte between the cathode and the anode.

According to another aspect, provided is a method for preparing a cathode, the method including: providing a first cathode active material sheet including a dopant-free first cathode active material or a first cathode active material having a first dopant concentration; disposing on a first surface of the first cathode active material sheet a second cathode active material sheet including a second cathode active material having a second dopant concentration; disposing a conductive metal layer on a second surface of the first cathode active material sheet to provide a laminate structure; and sintering the laminate structure to prepare the cathode, wherein the first dopant concentration in the first cathode active material is less than the second dopant concentration in the second cathode active material.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view schematically illustrating an embodiment of a structure of a cathode;

FIG. 2 is a cross-sectional view of the cathode shown in FIG. 1, taken along line A-A;

FIGS. 3A to 3G are each a graph of a dopant concentration (arbitrary units) versus dopant depth in the cathode active material layer (arbitrary units) from a first surface 12a of the cathode active material layer to the second surface 12b of the cathode active material layer, according to example embodiments;

FIGS. 4A to 4C are cross-sectional views of an embodiment of a multi-layered cathode active material layer including a plurality of layers;

FIG. 5 is a perspective view of an embodiment of a cathode active material layer having a channel structure;

FIG. 6 is a cross-sectional view of an embodiment of a cathode active material layer having a channel structure;

FIG. 7 is a perspective view of an embodiment of a multi-layered cathode active material layer including a plurality of layers;

FIG. 8 is a cross-sectional view of an embodiment of a multi-layered cathode active material layer including a plurality of layers having different dopant concentrations;

FIG. 9 is a cross-sectional view of an embodiment of a multi-layered cathode active material layer including a plurality of layers having different thicknesses;

FIG. 10 is a perspective view of an embodiment of a multi-layered cathode active material layer having a channel structure;

FIGS. 11A and 11B are perspective views of an embodiment of a plurality of cathode active material layer structures;

FIG. 12 is an exploded perspective view of the plurality of cathode active material layer structures shown in FIGS. 11A and 11B;

FIG. 13 is a cross-sectional view of the plurality of cathode active material layer structures shown in FIG. 11 taken along line A-A;

FIG. 14 is a cross-sectional view of an embodiment of a plurality of cathode active material layer structures;

FIG. 15 is a cross-sectional view of an embodiment of a plurality of cathode active material layer structures;

FIG. 16 is a cross-sectional view of another embodiment of a plurality of cathode active material layer structures;

FIGS. 17 and 18 are cross-sectional views of another embodiment of a cathode in which another cathode active material layer is added to the uppermost surface of a cathode active material layer structure;

FIG. 19 is a perspective view of an embodiment schematically showing a structure of an electrochemical cell 100;

FIG. 20 is a partial cross-sectional view of the electrochemical cell 100 of FIG. 19, showing the cathode active material layer structures of FIGS. 11A and 11B;

FIGS. 21A to 21F are perspective views for explaining a method of preparing a cathode; and

FIG. 22 is a scanning electron microscope image of a cross-section of the cathode prepared in Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

Hereinafter, a cathode according to example embodiments, an electrochemical cell including the same, and a method for preparing the same will be described in more detail with reference to the accompanying drawings.

In the drawings, the same reference numerals refer to the elements, and the sizes of various components are exaggerated or reduced for clarity and brevity. Also, the following embodiment is presented by way of example only, and various changes and modifications may be made from the description of these embodiments. In the following description, when an element is referred to as being “above” or “on” another element, it can be directly on the other element in a contact manner or in a non-contact manner. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. The terminology used herein is for the purpose of describing particular embodiments only and is not intended to be limiting. In addition, it will be understood that the terms “comprises or includes” and/or “comprising or including” when used in this specification, specify the addition and/or presence of one or more other features, regions, integers, steps, operations, elements, and/or components, but do not preclude the possibility of excluding the stated regions, integers, steps, operations, elements, and/or groups thereof components features, unless the context clearly indicates otherwise.

“Group” means a group of the Periodic Table of the Elements according to the International Union of Pure and Applied Chemistry (“IUPAC”) Group 1-18 group classification system.

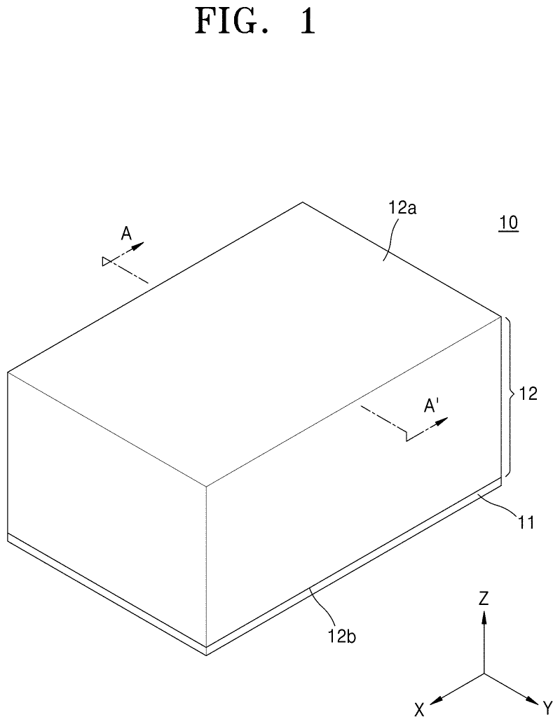

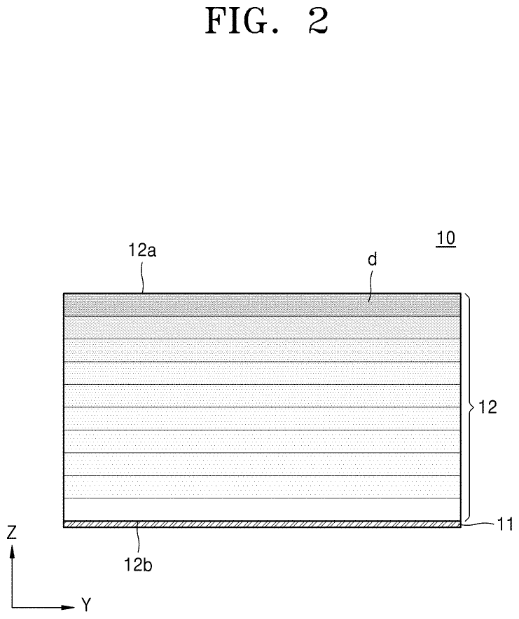

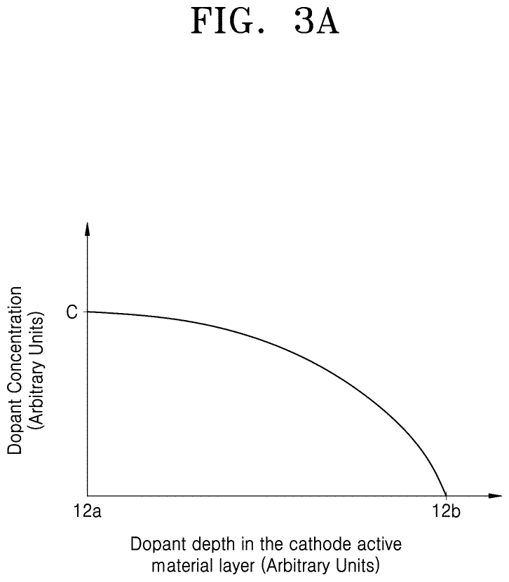

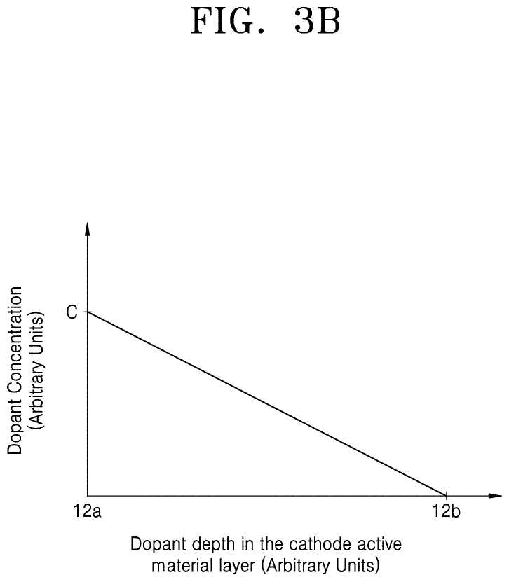

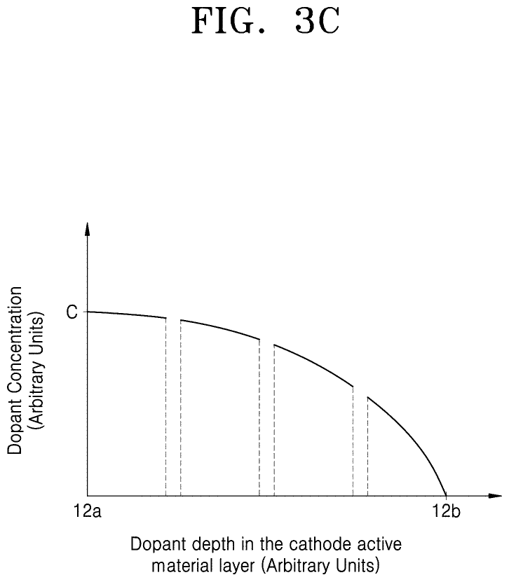

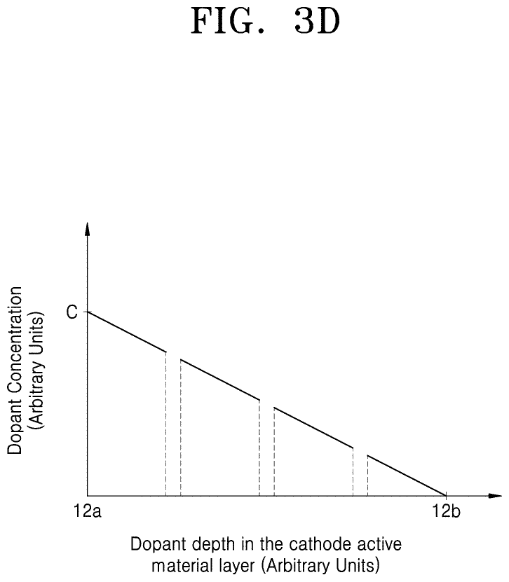

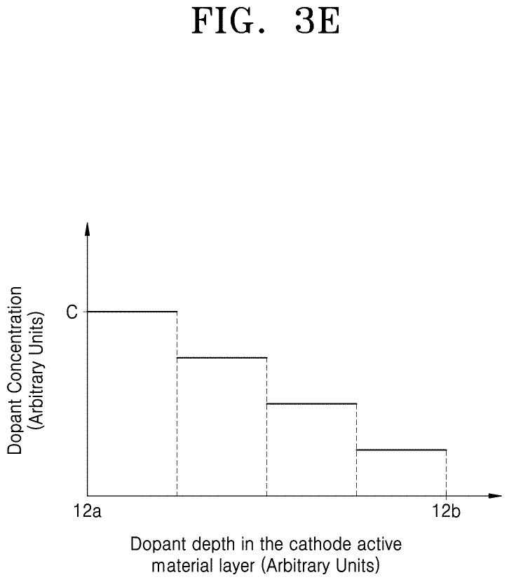

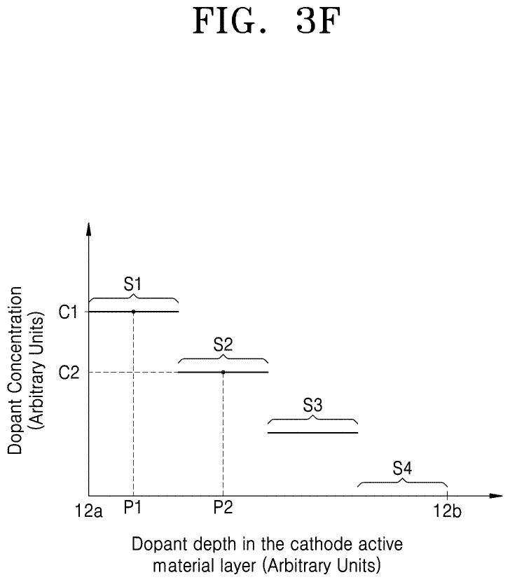

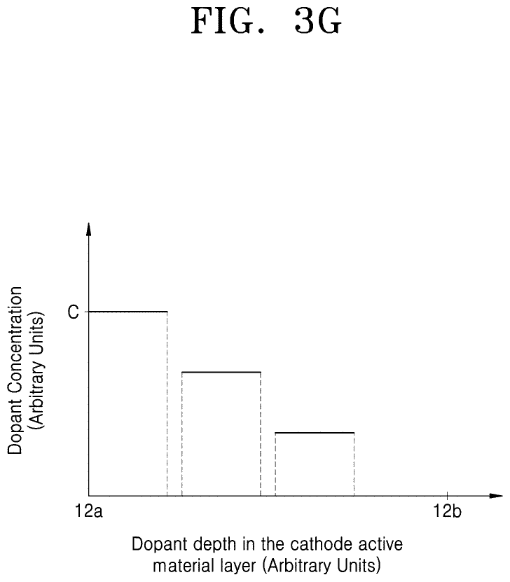

FIG. 1 is a perspective view schematically illustrating an embodiment of a structure of a cathode. FIG. 2 is a cross-sectional view of the cathode shown in FIG. 1, taken along the line A-A. FIGS. 3A to 3G each show a dopant concentration profile depending on the depth of the cathode active material layer from a first surface 12a of the cathode active material layer to a second surface 12b of the cathode active material layer according to example embodiments.

Referring to FIGS. 1 to 3G, the cathode 10 according to an embodiment includes: a cathode current collector 11; and a cathode active material layer 12 disposed on the cathode current collector 11 and including the first surface 12a and the second surface 12b opposite to the first surface and disposed adjacent to the cathode current collector 11, wherein the cathode active material layer 12 includes a cathode active material doped with a dopant d, and the cathode active material layer 12 has a concentration gradient in which the concentration C of the dopant decreases in a direction from the first surface 12a to the second surface 12b. The concentration gradient may be, for example, a concentration slope.

During charge and discharge, and while not wanting to be bound by theory, it is understood that non-uniform current distribution occurs due to cracks and surface defects of grain boundaries exposed on the surface of a cathode active material layer. Accordingly, localized over-lithiation takes place on the surface of the cathode active material layer, and a side reaction with an electrolyte increases. As a result, deterioration of the cathode is accelerated. Accordingly, the lifespan characteristics of a battery employing such a cathode are rapidly deteriorated.

However, in the cathode 10 according to an embodiment, the cathode active material layer 12 has a concentration gradient in which the concentration C of the dopant decreases it a direction from the first surface 12a to the second surface 12b, thereby effectively suppressing the deterioration of the cathode 10. For example, by including a dopant having an increasing concentration (e.g., a doped cathode active material containing an increasing concentration of dopant) in a region adjacent to the first surface 12a of the cathode active material layer, structural stability of the cathode active material layer 12 in the first surface 12a and an area adjacent thereto can be improved. Therefore, localized over-lithiation, which can occur during the charging/discharging process on first surface 12a of the cathode active material layer and an area adjacent thereto, and a side reaction between the cathode active material layer 12 and the electrolyte, can be effectively suppressed. In addition, by including a dopant having a relatively reduced concentration (for example, a doped cathode active material having a reduced concentration of dopant) in a region adjacent to the second surface 12b of the cathode active material layer, an increase in the internal resistance of the battery, which is understood to be caused by including the dopant, can be avoided or reduced. As a result, because the cathode 10 simultaneously provides suppression of side reactions and suppression of internal resistance increase, cycle characteristics of a battery including the cathode 10 can be improved.

Referring to FIGS. 3A to 3G, the cathode active material layer may have a concentration gradient in which the concentration of the dopant decreases in to provide a dopant concentration profile depending on the depth of the cathode active material layer 12 in the direction from the first surface 12a to the second surface 12b of the cathode active material layer. If the cathode active material layer has a concentration gradient in which the concentration of the dopant decreases depending on the depth of the cathode active material layer 12 in the direction from the first surface 12a to the second surface 12b of the cathode active material layer, the specific shape of the dopant concentration profile is not particularly limited, and may be determined within the range in which charging and discharging characteristics of battery are improved.

Referring to FIGS. 3A and 3B, in the dopant concentration profile, which depends on the depth of the cathode active material layer 12 in the direction from the first surface 12a to the second surface 12b of the cathode active material layer, the concentration gradient may have a single concentration slope or a plurality of concentration slopes. By having such a concentration gradient of the dopant, the deterioration of the cathode active material layer 12 in the region adjacent to the first surface 12a of the cathode active material layer 12 may be reduced or effectively prevented.

Referring to FIGS. 3C to 3G, in the dopant concentration profile, which depends on the depth of the cathode active material layer 12 in the direction from the first surface 12a to the second surface 12b of the cathode active material layer, the concentration gradient may decrease discontinuously. By having such a dopant concentration profile, the cathode active material layer 12 can reduce or effectively prevent the internal resistance of battery from increasing.

Referring to FIGS. 3E to 3G, in the dopant concentration profile, which depends on the depth of the cathode active material layer 12 in the direction from the first surface 12a to the second surface 12b of the cathode active material layer, the concentration of the dopant may decrease in a stepwise manner. By having such a dopant concentration profile, the cathode active material layer 12 can effectively control the increase in the internal resistance of battery. When the concentration of the dopant decreases in a stepwise manner in the dopant concentration profile, the concentration slope may be derived from a difference in the dopant concentration and a distance (depth) between adjacent steps. Referring to FIG. 3F, the dopant concentration profile may comprise a first section S1, a second section S2, a third section S3, and a fourth section S4, and the dopant concentration may decrease in a stepwise manner from the first section to the fourth section. The first section may have a dopant concentration C1, the second section may have a dopant concentration C2. As shown in FIG. 3F, a middle position of the first section is P1, and a middle position of the second section is P2, and a difference in the dopant concentration between the first section and the second section may be C2−C1, and a difference in the pitch between the middle positions of the first section and the second section may be P2−P1, and the concentration gradient can be derived from a ratio thereof (i.e., (C2−C1)/(P2−P1)).

Referring to FIGS. 1 to 3G, the second surface of the cathode active material layer may have a minimum value of the dopant concentration C, or the second surface of the cathode active material layer may be a dopant-free cathode active material layer. Since the region of the cathode active material layer adjacent to the current collector has a minimum value of the dopant concentration C, or is a dopant-free region of the cathode active material layer, interfacial resistance between the second surface 12b of the cathode active material layer and the region adjacent thereto, and/or between the second surface 12b of the cathode active material layer and the cathode current collector can be more effectively reduced. Accordingly, the cycle characteristics of the battery including the cathode 10 may be further improved.

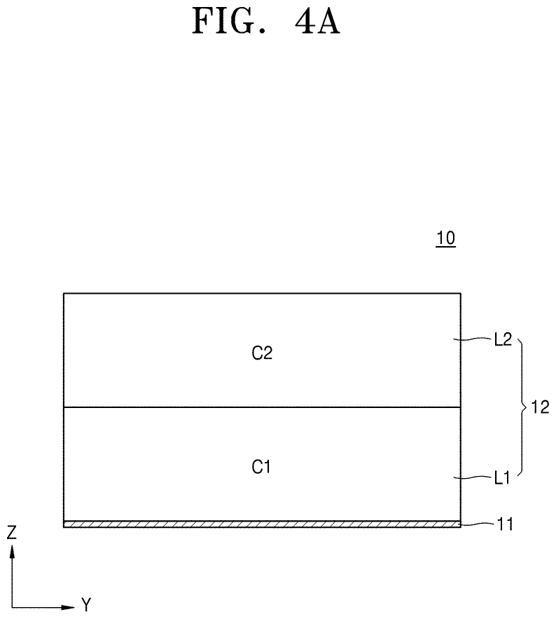

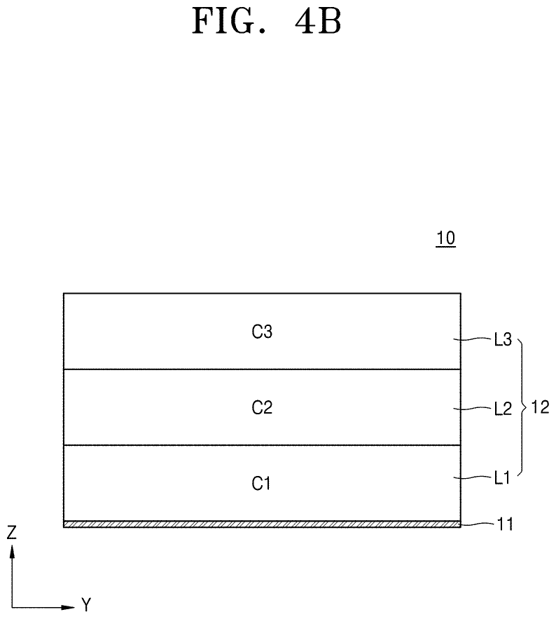

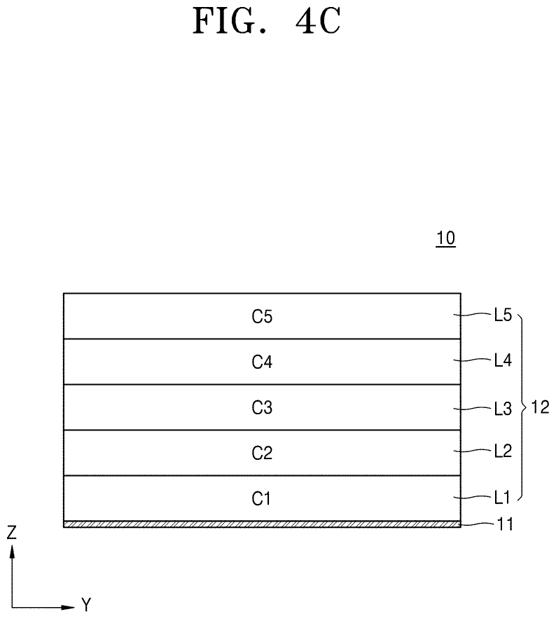

FIGS. 4A to 4C are cross-sectional views of an embodiment of a multi-layered cathode active material layer including a plurality of layers.

Referring to FIGS. 4A to 4C, the cathode active material layer 12 may include a plurality of layers, e.g., L1, L2, L3, L4, and L5, disposed in a thickness direction. In an aspect, the thickness direction is perpendicular or orthogonal to a major surface of the cathode current collector. The plurality of layers may include, for example, two, three, four, five, or more layers. The plurality of layers may include, for example, 2 to 1000 layers. By providing the cathode active material layer 12 including a plurality of layers, the dopant concentration gradient in the cathode active material layer 12 can be more easily controlled.

The cathode active material layer 12 includes, for example, a plurality of layers, e.g., L1, L2, L3, L4, and L5, disposed in the thickness direction, and each layer of the plurality of layers, e.g., L1, L2, L3, L4, and L5, may have a different dopant concentration, e.g., a dopant concentration C1, C2, C3, C4, and C5, respectively.

The layers may be arranged so that the dopant concentrations of the layers sequentially decrease in the thickness direction, for example, from the first surface 12a to the second surface 12b of the cathode active material layer.

The plurality of layers may have, for example, dopant concentrations C1 to Cn, wherein the dopant concentrations C1 to Cn correspond to layers L1 to Ln, respectively, and the dopant concentrations C1 to Cn may satisfy Formula 1:

0≤C(n−1)<Cn Formula 1

wherein n is 2 to 1000, and n is the total number of layers.

For example, the cathode active material layer 12 includes a first layer, second to (n−1)th layers, and an nth layer, which are disposed in the thickness direction, and the first layer, the second layer, (n−1)th layer, and the nth layer have dopant concentrations C1, C2, . . . , C(n−1), and Cn, respectively. The cathode active material layer 12 may have dopant concentrations that satisfy the relationship: 0≤C1<C2< . . . <C(n−1)<Cn.

The dopant concentration in the cathode active material layer 12 may be represented by, for example, a molar ratio of the dopant to the total number of moles of elements other than lithium, oxygen, phosphorus, sulfur, or halogen included in the cathode active material. The molar ratio of the dopant to the total number of moles of elements other than lithium, oxygen, phosphorus, sulfur, or halogen included in the cathode active material may be about 0.0001 to about 0.1, or about 0.001 to about 0.01. In an aspect the dopant concentration is a molar content of the dopant relative to the total moles of transition metal included in the cathode active material. In an aspect the dopant concentration is a molar content of the dopant relative to the total moles of Co, Ni, Mn, or Al, or a combination thereof, included in the cathode active material.

The dopant concentration in the doped cathode active material may be about 0.01 mole percent (mol %) to about 10 mol %, or about 0.05 mol % to about 5 mol %, or about 0.1 mol % to about 1 mol %, based on a total moles of elements other than lithium, oxygen, phosphorus, sulfur, or halogen included in the cathode active material. In an aspect, the dopant concentration in the doped cathode active material may be about 0.01 mole percent (mol %) to about 10 mol %, or about 0.05 mol % to about 5 mol %, or about 0.1 mol % to about 1 mol %, based on a total moles of transition metal included in the cathode active material. In an aspect, the dopant concentration in the doped cathode active material may be about 0.01 mole percent (mol %) to about 10 mol %, or about 0.05 mol % to about 5 mol %, or about 0.1 mol % to about 1 mol %, based on the total moles of Co, Ni, Mn, or Al, or a combination thereof, included in the cathode active material. The dopant concentration may be represented by the average dopant concentration in the cathode active material. If the dopant concentration in the doped cathode active material is too low, the effect of improving the stability of the cathode active material layer may be negligible, and if the dopant concentration in the doped cathode active material is excessively increased, the internal resistance of the cathode active material layer may be excessively increased.

The dopant may alternatively include, for example, one of Group 2 to Group 16 element belonging to the third period to sixth period of the Periodic Table of the Elements, or boron (B). The dopant may include, for example, one of Group 2 to Group 16 elements belonging to the third period to sixth period of the Periodic Table of the Elements, boron (B), or a combination thereof.

The dopant may include, for example, titanium (Ti), magnesium (Mg), aluminum (Al), gallium (Ga), silicon (Si), tin (Sn), nickel (Ni), yttrium (Y), vanadium (V), zirconium (Zr), hafnium (Hf), iron (Fe), chromium (Cr), copper (Cu), zinc (Zn), molybdenum (Mo), tungsten (W), niobium (Nb), manganese (Mn), tellurium (Te), barium (Ba), antimony (Sb), tantalum (Ta), germanium (Ge), boron (B), or a combination thereof.

The dopant may include, for example, a combination of titanium, magnesium, aluminum, or a combination thereof. The specific composition thereof can be appropriately selected.

Referring to FIGS. 1 to 4C, the cathode active material layer 12 may be, for example, a sintered layer prepared through a sintering process. The sintered layer may provide an increased density compared to a layer prepared by simply mixing and drying cathode active material particles. Accordingly, the energy density of the battery employing the cathode 10 including the cathode active material layer 12 may be improved.

Referring to FIGS. 1 to 4C, the cathode active material layer 12 included in the cathode 10 may be a binder-free layer that does not include a binder since the binder is removed by heat treatment during the sintering process. Since the cathode active material layer 12 does not include a binder, the energy density of the cathode active material layer 12 may be further improved. The cathode active material layer 12 is a sintered layer and may be a binder-free layer.

Referring to FIGS. 1 to 4C, the cathode active material layer 12 includes a doped cathode active material, the doped cathode active material includes, for example, single crystal particles and/or polycrystalline particles, and the dopant may be homogeneously distributed within the single crystal particles and/or the polycrystalline particles. The cathode active material layer 12 of the present disclosure includes a doped cathode active material, and the doped cathode active material may not have a concentration gradient in the cathode active material particles and have a dopant concentration gradient in the cathode active material layer 12. However, a cathode active material layer of the related art includes a doped cathode active material, and the doped cathode active material has a concentration gradient in the cathode active material particles and does not have a dopant concentration gradient in the cathode active material layer 12. In addition, the cathode active material layer of the related art includes a doped cathode active material, the doped cathode active material does not have a concentration gradient in the cathode active material particles and does not have a dopant concentration gradient inside the cathode active material layer 12. The doped cathode active material may include, for example, a plurality of crystallites, and the plurality of crystallites may be oriented in a first direction, for example. Major axes of the plurality of crystallites may be arranged, for example, in a first direction (e.g., a Z direction) of the cathode active material layer 12 or in a direction perpendicular to the first direction. Major axes of the plurality of crystallites may be arranged, for example, in a second direction (e.g., an X direction) or in a third direction (e.g., a Y direction).

Referring to FIGS. 1 to 4C, the density of the cathode active material layer 12 included in the cathode 10 may be, for example, about 4.0 grams per cubic centimeter (g/cc)—to about 4.9 g/cc, about 4.2 g/cc to about 4.8 g/cc, or about 4.3 g/cc—about 4.7 g/cc. The cathode active material layer 12 has such a high density by being, for example, a sintered material, and by having the cathode active material layer 12 having such a high density, it is possible to provide an increased energy density compared to a current battery.

Referring to FIGS. 1 to 4C, the cathode active material layer 12 includes a doped cathode active material, and the doped cathode active material may include, for example, a compound represented by the following chemical formulas 1 to 4, or a combination thereof:

LiₐCoₓM_{y}O_{2-α}X_{α} Chemical Formula 1

wherein, in Chemical Formula 1,

1.0≤a≤1.2, 0.9≤x<1, 0<y≤0.1, 0≤α≤0.2, and x+y=1,

M is titanium (Ti), magnesium (Mg), aluminum (Al), gallium (Ga), silicon (Si), tin (Sn), nickel (Ni), yttrium (Y), vanadium (V), zirconium (Zr)), hafnium (Hf), iron (Fe), chromium (Cr), copper (Cu), zinc (Zn), molybdenum (Mo), tungsten (W), niobium (Nb), manganese (Mn), tellurium (Te), barium (Ba), antimony (Sb), tantalum (Ta), germanium (Ge), boron (B), or a combination thereof, and

X is F, S, Cl, Br, or a combination thereof;

LiₐNiₓCo_{y}Mn_{z}Al_{w}MᵥO_{2-α}X_{α} Chemical Formula 2

where, in Chemical Formula 2,

1.0≤a≤1.2, 0<x<1, 0≤y<1, 0≤z<1, 0≤w<1, 0<v≤0.1, 0≤α≤0.2, and x+y+z+w+v=1,

M is titanium (Ti), magnesium (Mg), gallium (Ga), silicon (Si), tin (Sn), yttrium (Y), vanadium (V), zirconium (Zr), hafnium (Hf), iron (Fe), chromium (Cr), copper (Cu), zinc (Zn), molybdenum (Mo), tungsten (W), niobium (Nb), tellurium (Te), barium (Ba), antimony (Sb), tantalum (Ta), germanium (Ge), boron (B), or a combination thereof, and

X is F, S, Cl, Br, or a combination thereof;

LiₐMn₂₋ₓMₓO_{4-α}Xα Chemical Formula 3

wherein, in Chemical Formula 3,

0.9≤a≤1.1, 0<x≤0.1, 0≤α≤0.2,

M is titanium (Ti), magnesium (Mg), aluminum (Al), gallium (Ga), silicon (Si), tin (Sn), nickel (Ni), yttrium (Y), vanadium (V), zirconium (Zr), hafnium (Hf), iron (Fe), chromium (Cr), copper (Cu), zinc (Zn), molybdenum (Mo), cobalt (Co), tungsten (W), niobium (Nb), tellurium (Te), barium (Ba), antimony (Sb), tantalum (Ta), germanium (Ge), boron (B), or a combination thereof, and

X is F, S, Cl, Br, or a combination thereof; or

LiₐFe_{b}Mn_{c}Co_{d}NiₑMₓPO_{4-α}X_{α} Chemical Formula 4

wherein, in Chemical Formula 4,

0.9≤a≤1.1, 0≤b<1, 0≤c<1, 0≤d<1, 0≤e<1, 0<x≤0.1, b+c+d+e+x=1, 0≤α≤0.2

M is titanium (Ti), magnesium (Mg), aluminum (Al), gallium (Ga), silicon (Si), tin (Sn), yttrium (Y), vanadium (V), zirconium (Zr), hafnium (Hf), chromium (Cr), copper (Cu), zinc (Zn), molybdenum (Mo), tungsten (W), niobium (Nb), tellurium (Te), barium (Ba), antimony (Sb), tantalum (Ta), germanium (Ge), boron (B), or a combination thereof, and

X is F, S, Cl, Br, or a combination thereof.

Referring to FIGS. 1 to 4C, the cathode active material layer 12 may additionally include an undoped cathode active material. The undoped cathode active material may include, for example, a compound represented by the following chemical formulas 5 to 8, or a combination thereof:

LiₐCoO_{2-α}X_{α} Chemical Formula 5

wherein, in chemical formula 5,

1.0≤a≤1.2, 0≤α≤0.2, and

X is F, S, Cl, Br, or a combination thereof;

LiₐNiₓCo_{y}Mn_{z}Al_{w}O_{2-α}X_{α} Chemical Formula 6

wherein, in chemical formula 6,

1.0≤a≤1.2, 0<x<1, 0≤y<1, 0≤z<1, 0≤w<1, 0≤α≤0.2, and x+y+z+w=1, and

X is F, S, Cl, Br, or a combination thereof;

LiₐMn₂O_{4-α}Xα Chemical Formula 7

wherein, in chemical formula 7,

0.9≤a≤1.1, 0≤α≤0.2, and

X is F, S, Cl, Br, or a combination thereof; and

LiₐFe_{b}Mn_{c}Co_{d}NiₑPO_{4-α}X_{α} Chemical Formula 8

wherein, in chemical formula 8,

0.9≤a≤1.1, 0≤b<1, 0≤c<1, 0≤d<1, 0≤e<1, b+c+d+e+x=1, 0≤α≤0.2, and

X is F, S, Cl, Br, or a combination thereof.

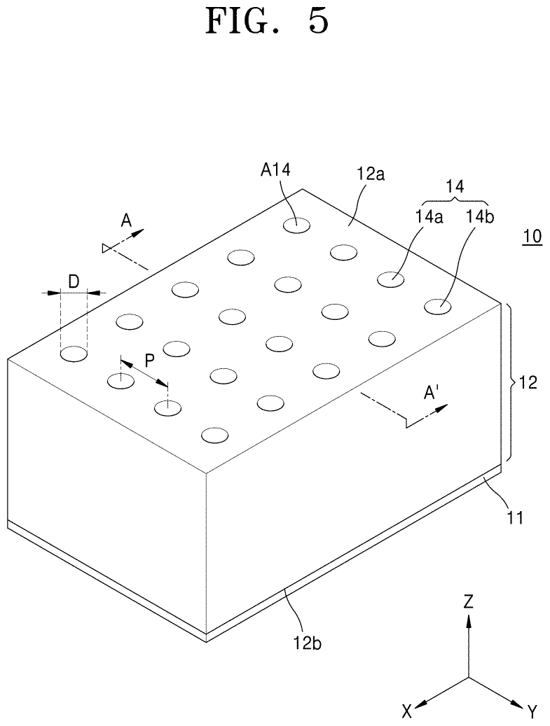

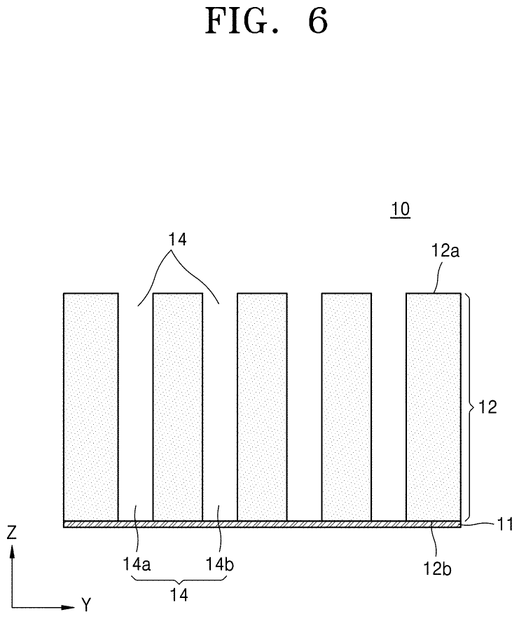

FIG. 5 is a perspective view of an embodiment of a cathode active material layer having a channel structure. FIG. 6 is a cross-sectional view of an embodiment of the cathode active material layer having the channel structure.

Referring to FIGS. 5 and 6, the cathode active material layer 12 having a three-dimensional structure may further include a channel structure 14 extending toward the second surface 12b of the cathode active material layer from first surface 12a of the cathode active material layer.

By the cathode active material layer 12 having the channel structure 14, the reaction area of the cathode active material layer 12 may be increased. In addition, by the cathode active material layer 12 having the channel structure 14, after assembling the battery, an electrolyte (not shown) is disposed to the inside of the cathode active material layer 12, and thus the ion conduction path in the cathode active material layer 12 can be significantly reduced. Therefore, the battery comprising the cathode 10 including the cathode active material layer 12 having the channel structure 14 may have improved cycle characteristics, such as high-rate characteristics of battery.

The channel structure 14 including the cathode active material layer 12 may include, for example, through-holes extending from the first surface 12a to the -second surface 12b of the cathode active material layer. Accordingly, one or more channels 14a and 14b constituting the channel structure 14 may be, for example, through-holes. By the channel structure 14 including the through-holes, lithium ions may be more easily conducted to the inside of the cathode active material layer 12 adjacent to the cathode current collector 11. As a result, the non-uniformity of the current distribution between the region adjacent to the first surface 12a of the cathode active material layer and the region adjacent to the second surface 12b of the cathode active material layer can be suppressed.

An area A14 of the one or more channels 14a and 14b with respect to the total area of the first surface 12a of the cathode active material layer, e.g., measured perpendicular to the thickness direction (Z direction) of the cathode active material layer, is, for example, about 1 percent (%)—to about 15%, about 1% to about 10%, or about 1 to about 5%, based on the total area of the first surface of the cathode active material layer. If the area A14 of the one or more channels 14a and 14b is excessively increased, the energy density of battery is reduced. If the area A14 of the one or more channels 14a and 14b is excessively reduced, the effect exerted by introducing the channels may be difficult to be exhibited.

The diameter (D) of the one or more channels 14a and 14b included in the cathode active material layer 12 may be, for example, about 10 μm to about 300 μm, about 10 μm to about 200 μm, about 20 μm to about 150 μm, about 30 μm to about 100 μm, or about 10 μm to about 100 μm. By the channel having the diameter in such a range, cycle characteristics of the battery including the cathode 10 can be further improved.

A pitch, e.g., pitch P1, at which the plurality of channels 14a and 14b included in the cathode active material layer 12 are spaced apart from each other may be, for example, about 50 micrometers (μm)—to about 1000 μm, about 50 μm—to about 750 μm, about 50 μm—to about 500 μm, or about 50 μm—to about 250 μm. By having a plurality of channels having a pitch in such a range, cycle characteristics of battery including a cathode can be further improved.

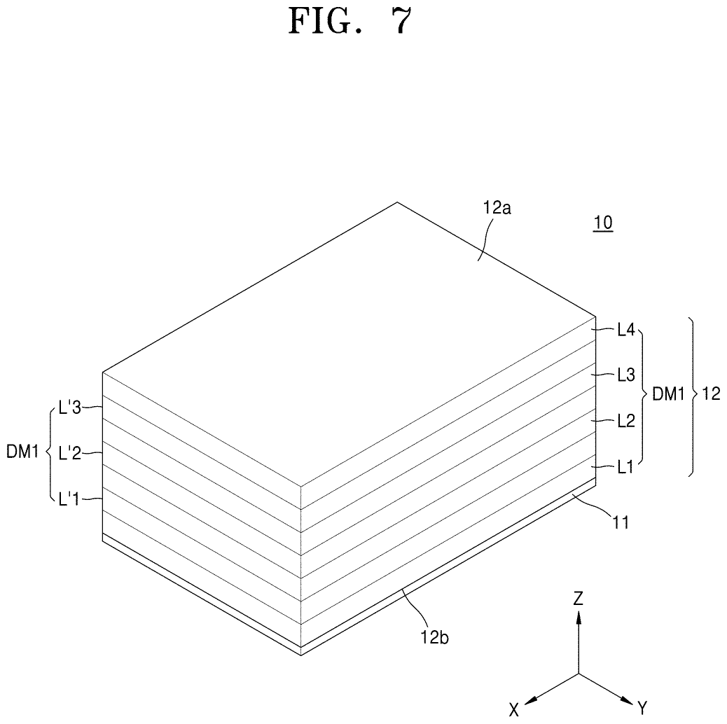

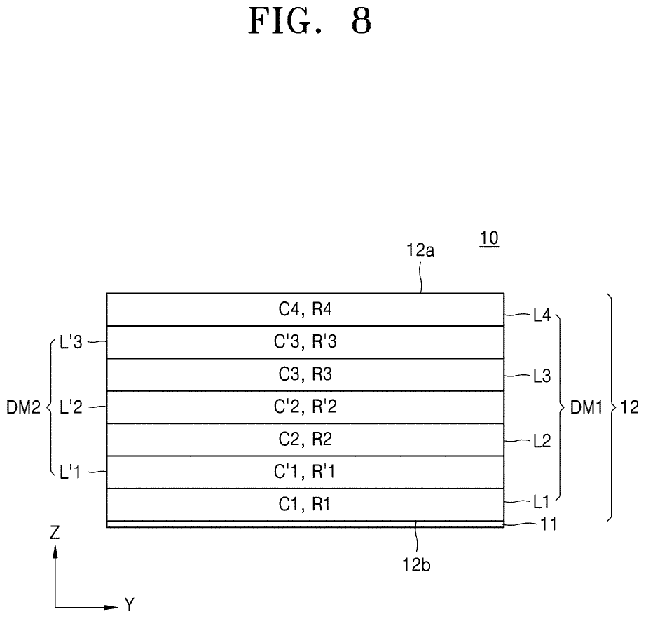

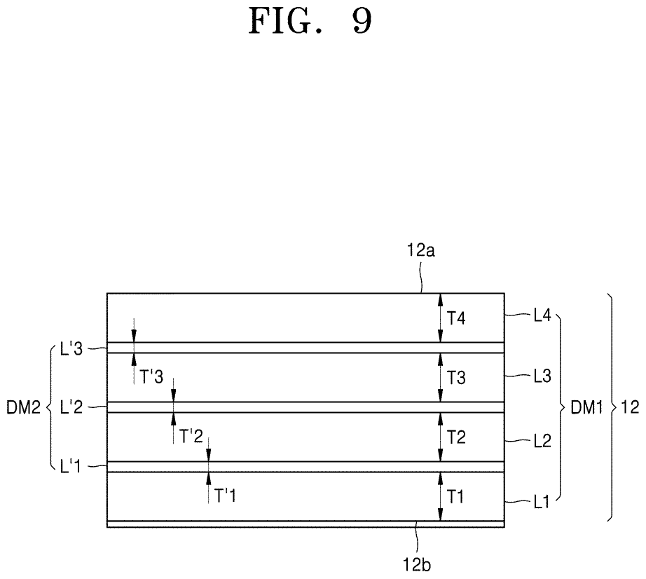

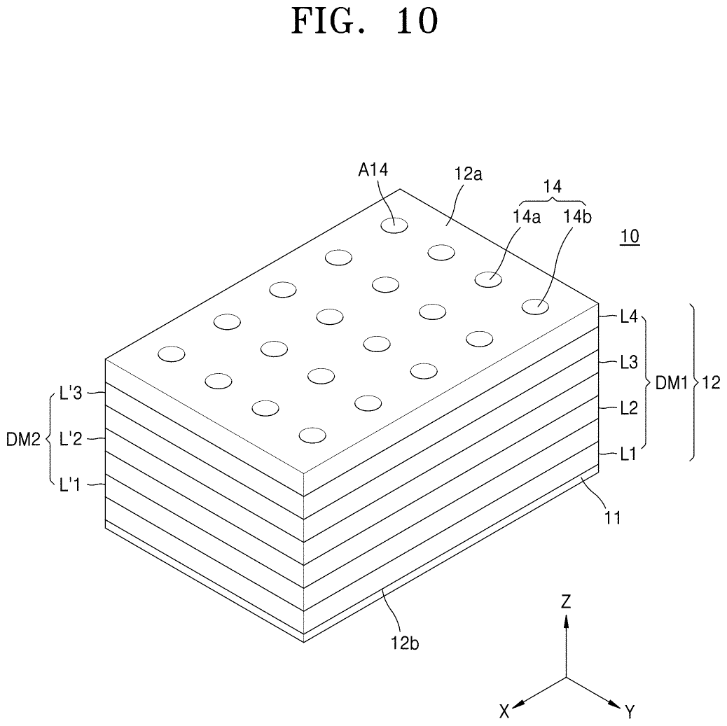

FIG. 7 is a perspective view of an embodiment of a multi-layered cathode active material layer including a plurality of layers. FIG. 8 is a cross-sectional view of an embodiment of a multi-layered cathode active material layer including a plurality of layers having different dopant concentrations. FIG. 9 is a cross-sectional view of an embodiment of a multi-layered cathode active material layer including a plurality of layers having different thicknesses. FIG. 10 is a cross-sectional view of an embodiment of a multi-layered cathode active material layer having a channel structure.

Referring to FIGS. 7 to 9, the cathode active material layer 12 includes a first domain DM1, which includes a plurality of layers, e.g., layers L1, L2, L3, and L4, disposed in the direction from the first surface 12a to the second surface 12b of the cathode active material layer; and a second domain DM2, which includes a layer or a plurality of layers, e.g., layers L′1, L′2, and L′3 respectively disposed between the plurality of layers L1, L2, L3, and L4 of the first domain DM1. The layers of the second domain DM2 may be interdigitatively disposed between the layers of the first domain DM1. The plurality of layers, e.g., layers L1, L2, L3, and L4, of the first domain DM1, may each have a different dopant concentration, e.g., C1, C2, C3, and C4, respectively, and may be arranged such that the different dopant concentrations, e.g., C1, C2, C3, and C4, sequentially decrease from the first surface 12a to the second surface 12b of the cathode active material layer. A layer or a plurality of layers, e.g., layers L′1, L′2, and L′3 of the second domain, may have dopant concentrations different from those of a plurality of layers, e.g., layers L1, L2, L3, and L4, of the first domain DM1. By additionally including the second domain DM2 in addition to the first domain DM1, the cathode active material layer 12 may provide a concentration gradient in which the dopant concentration decreases from the first surface 12a to the second surface 12b of the cathode active material layer 12.

For example, dopant concentrations of the second domain, e.g., C′1, C′2, and C′3, of the layers of the second domain, e.g., layers L′1, L′2, and L′3 of the second domain DM2, may be less than minimum values of dopant concentrations, e.g., C1, C2, C3, and C4, of the layers of the first domain DM1, e.g., layers L1, L2, L3, L4. By providing the second domain DM2 having such lower dopant concentrations, the concentrations of dopants included in the cathode active material layer 12 may be reduced as a whole, and as a result, the internal resistance of the cathode active material layer 12 may be reduced.

For example, the layer or the plurality of layers L′1, L′2, and L′3 of the second domain DM2 may be a dopant-free layer that does not include a dopant. By providing the second domain DM2 not including a dopant, the concentration of the dopant included in the cathode active material layer 12 may be reduced as a whole, and as a result, the internal resistance of the cathode active material layer 12 may be reduced.

Also, the respective porosities, e.g., porosities R1, R2, R3, and R4, of the plurality of layers L1, L2, L3, and L4, respectively, of the first domain DM1 may be less than the porosities R′1, R′2, and R′3 of the layer or the plurality of layers L′1, L′2, and L′3, respectively. That is, the second domain DM2 may have an increased porosity compared to the first domain DM1. Accordingly, the second domain DM2 may act as an ion conduction channel when an electrolyte (not shown) is disposed in the pores of the increased volume included in the second domain DM2. Accordingly, cycle characteristics, such as high rate characteristics of the cathode active material layer 12 including the second domain DM2, may be improved. In addition, by the first domain DM1 having less porosity than the second domain DM2, the domain DM1 has greater active material density, and as a result, the energy density of a battery including the cathode active material layer 12 including the first domain DM1 can be improved.

For example, the respective thicknesses T1, T2, T3, and T4 of the plurality of layers L1, L2, L3, and L4, respectively, of the first domain DM1 may be less than the thickness T′1, T′2, and T′3 of the one layer or the plurality of layers L′1, L′2, and L′3, respectively, of the second domain DM2. That is, the second domain DM2 may have a reduced thickness compared to the first domain DM1. Therefore, the thickness of the second domain DM2 serving as an ion conduction channel is reduced and the thickness of the first domain DM1, having greater energy density, is increased, thereby increasing the energy density of the cathode active material layer 12. Accordingly, the energy density of the battery including the cathode active material layer 12 can be improved.

Referring to FIG. 10, the cathode active material layer 12 having a three-dimensional structure and including the first domain DM1 and the second domain DM2 may further include a channel structure 14 extending from the first surface 12a to the second surface 12b of the cathode active material layer.

The plurality of layers, e.g., layers L1, L2, L3, and L4 of the first domain DM1, the layer or the plurality of layers, e.g., layers L′1, L′2, and L′3 of the second domain DM2, or a combination thereof, may include a plurality of through-holes extending from the first surface 12a to the second surface 12b of the cathode active material layer. Accordingly, one or more channels 14a and 14b of the channel structure 14 may be, for example, through-holes. The cathode active material layer 12 including the second domain DM2 acting as an ion conduction channel may further include a plurality of through-holes, thereby enabling rapid ion conduction inside of the thickness direction of the cathode active material layer 12 adjacent to cathode current collector 11 in the thickness direction of the cathode active material layer 12 as well as the ion conduction by the second domain DM2 in a direction perpendicular to the thickness direction of the cathode active material layer 12. Consequently, cycle characteristics of the battery, which includes the cathode active material layer 12 including the second domain DM2 and a plurality of through-holes, may be further improved.

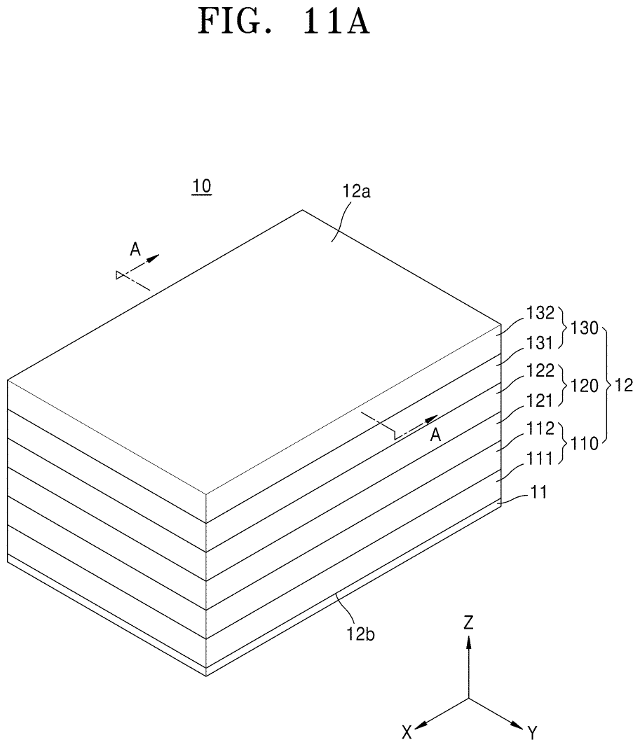

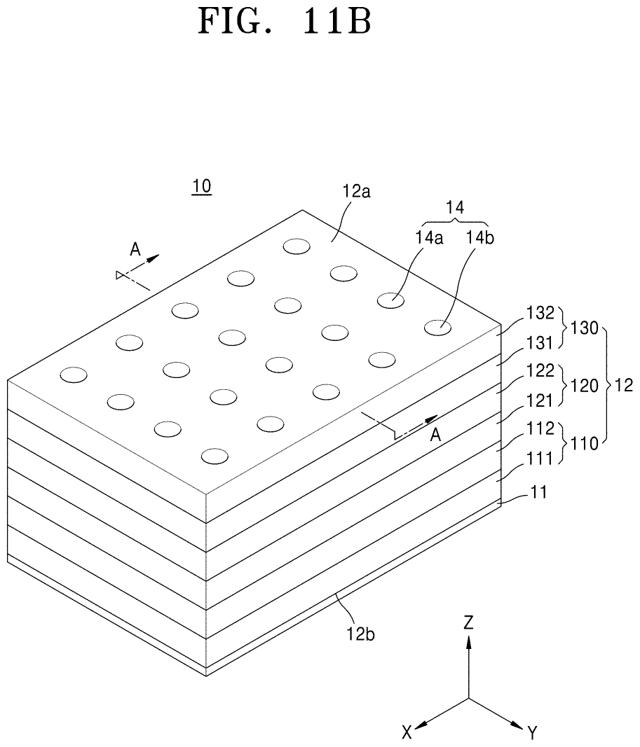

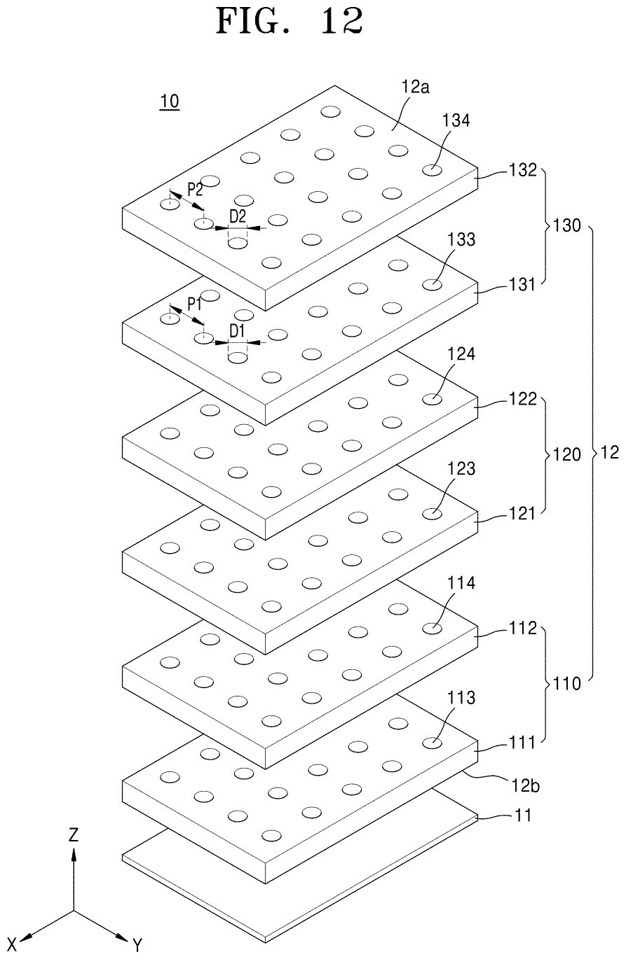

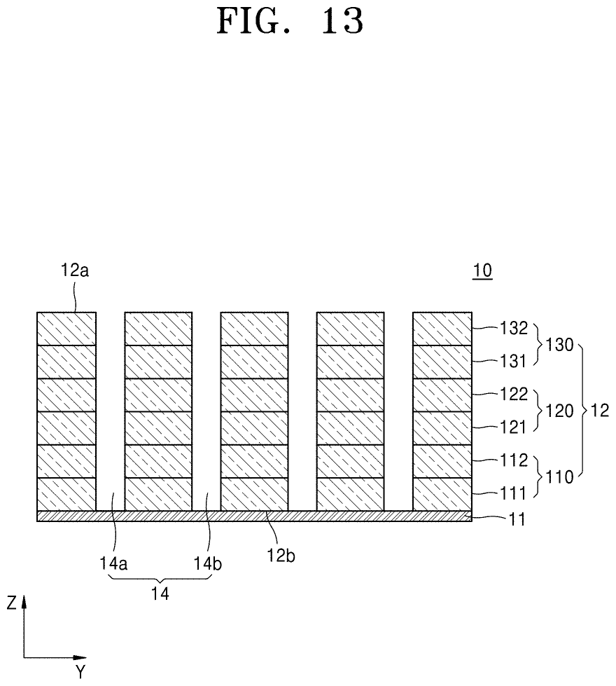

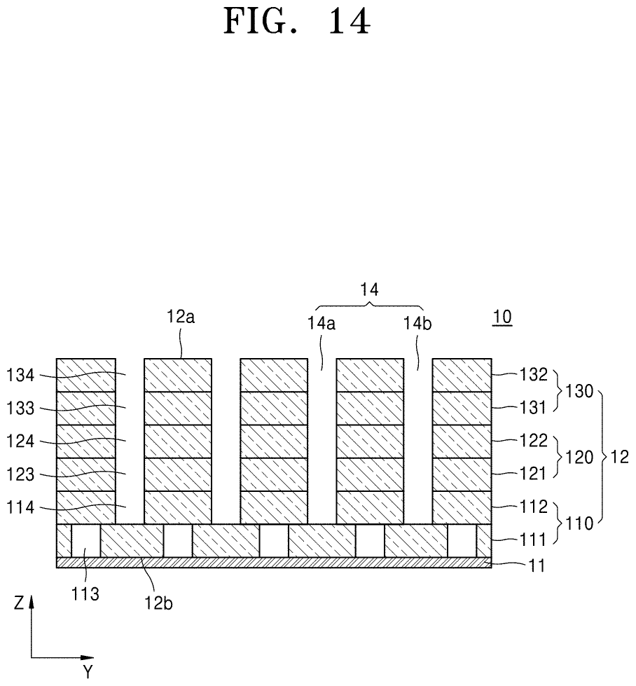

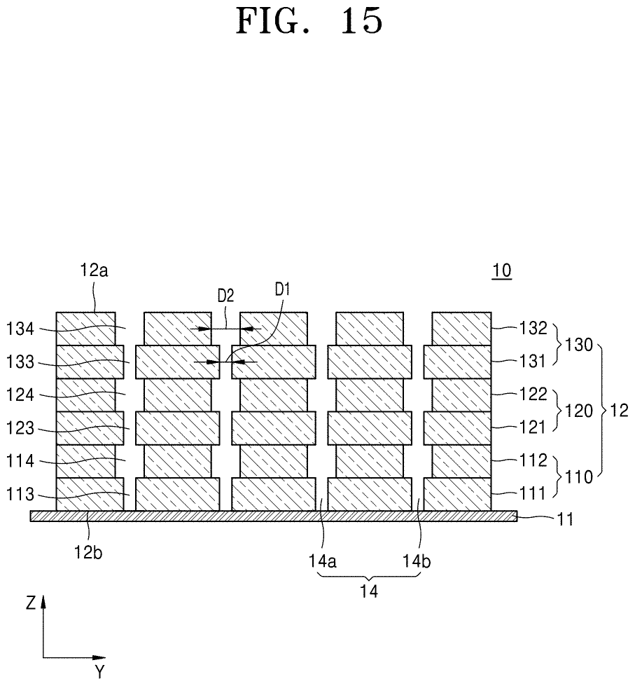

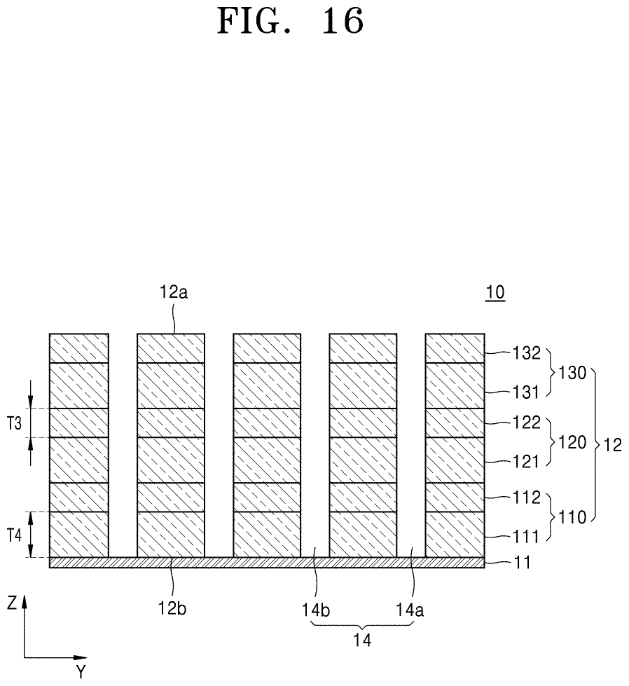

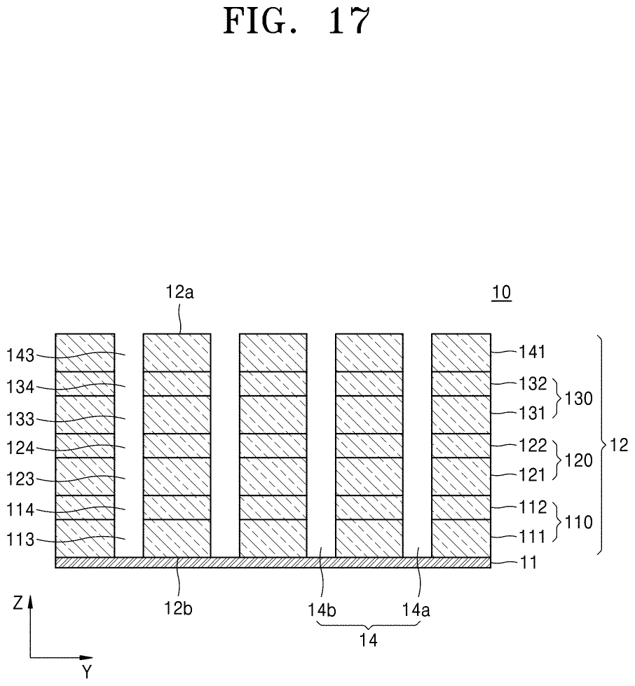

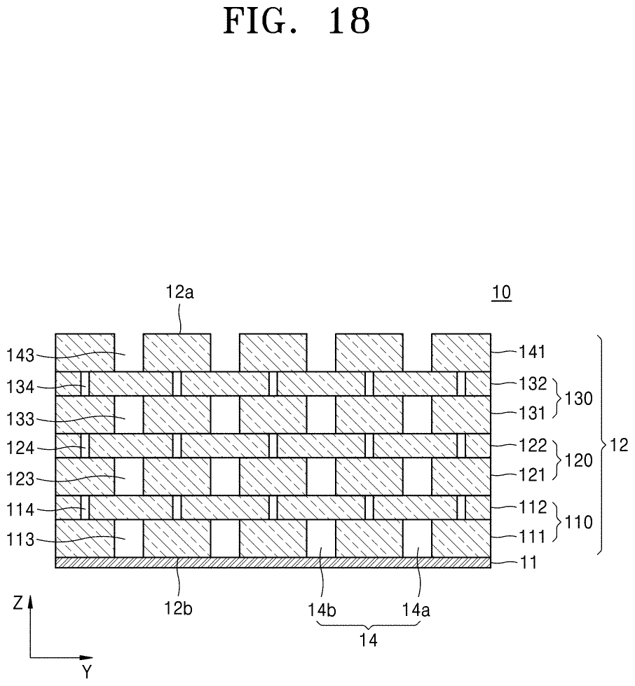

FIGS. 11A and 11B are perspective views of an embodiment of a plurality of cathode active material layer structures. FIG. 12 is an exploded perspective view of the plurality of cathode active material layer structures shown in FIGS. 11A and 11B. FIG. 13 is a cross-sectional view taken along line A-A of the plurality of cathode active material layer structures shown in FIGS. 11A and 11B. FIG. 14 is a cross-sectional view of an embodiment of a plurality of cathode active material layer structures. FIG. 15 is a cross-sectional view of another embodiment of a plurality of cathode active material layer structures. FIG. 16 is a cross-sectional view of another embodiment of a plurality of cathode active material layer structures. FIGS. 17 and 18 are cross-sectional views of another embodiment of a cathode in which another cathode active material layer is added to the uppermost surface of the cathode active material layer structure.

Referring to FIGS. 11A to 14, the cathode 10 includes a cathode current collector 11 and a cathode active material layer 12 disposed on the cathode current collector 11. The cathode active material layer 12 includes one or more cathode active material layer structures 110, 120, and 130 that are disposed in the thickness direction. The one or more cathode active material layer structures 110, 120, and 130 include first cathode active material layers 111, 121, and 131 and second cathode active material layers 112, 122, and 132 disposed on the first cathode active material layers 111, 121, and 131, respectively, in the thickness direction. The first cathode active material layers 111, 121, and 131 include a plurality of first through-holes 113, 123, and 133. In FIGS. 11 to 13, three active material layer structures are shown, however one, two, or four, or more may be used. Although not shown, the first cathode active material layers 111, 121, and 131 or the second cathode active material layers 112, 122, and 132 may be additionally disposed on the first surface 12a and/or the second surface 12b of the cathode active material layer 12. The composition or thickness of each of the one or more first cathode active material layers 111, 121, and 131 and the one or more second cathode active material layers 112, 122, and 132 included in the cathode active material layer structures 110, 120, and 130 may be selected to have the same value or different values depending on the desired energy density and/or discharge capacity of the battery, within a range having a concentration gradient in which the concentration of the dopant decreases in the direction from the first surface 12a to the second surface 12b of the cathode active material layer. The number of the one or more first cathode active material layers 111, 121, and 131 and the one or more second cathode active material layers 112, 122, and 132 included in the cathode active material layer structures 110, 120, and 130, may also be increased or reduced according to the battery structure required. The second cathode active material layers 112, 122, and 132 may or may not include through-holes.

Referring to FIGS. 11 to 13, the second, fourth, and sixth cathode active material layers 112, 122, and 132 may include a plurality of second, fourth, and sixth through-holes 114, 124, and 134, respectively extending in the thickness direction, for example. One or more of the plurality of first, third, and fifth through-holes 113, 123, and 133 included in the first, third, and fifth cathode active material layers 111, 121, and 131, respectively, and the plurality of second, fourth, and sixth through-holes 114, 124, and 134 included in the second, fourth, and sixth cathode active material layers 112, 122, and 132, respectively may be disposed to be aligned in the first direction. For example, a plurality of first through-holes 113 included in the first cathode active material layer 111, a plurality of second through-holes 114 included in the second cathode active material layer 112, a plurality of third through-holes 123 included in the third cathode active material layer 121, a plurality of fourth through-holes 124 included in the fourth cathode active material layer 122, a plurality of fifth through-holes 133 included in the fifth cathode active material layer 131, and a plurality of sixth through-holes 134 included in the sixth cathode active material layer 132, may be arranged to be aligned in the first direction (Z direction), thereby forming a channel structure 14. The channel structure 14 includes one or more channels 14a and 14b. The through-holes may be arranged to be aligned in the first direction to form the channel structure 14, thereby further improving the high-rate characteristic of the battery.

Referring to FIGS. 11 to 14, the second, fourth, and sixth cathode active material layers 112, 122, and 132 may include a plurality of second, fourth, and sixth through-holes 114, 124, and 134 extending in the thickness direction, for example. Referring to FIG. 14, one or more of the plurality of first, third, and fifth through-holes 113, 123, and 133 included in the first, third, and fifth cathode active material layers 111, 121, and 131 and the plurality of second, fourth, and sixth through-holes 114, 124, and 134 included in the second, fourth, and sixth cathode active material layers 112, 122, and 132 may be disposed in a non-aligned configuration, e.g., alternately disposed, in the first direction (Z direction). The cathode active material layer 12 may include, for example, a first cathode active material layer structure 110, a second cathode active material layer structure 120 and a third cathode active material layer structure 130, a first cathode active material layer structures 110 may include the first cathode active material layer 111 and a second cathode active material layer 112 disposed to be stacked on the first cathode active material layer 111 in the first direction, the first cathode active material layer 111 may include a plurality of first through-holes 113 extending along the first direction, the second cathode active material layer 112 may include a plurality of second through-holes 114 extending in the first direction, and the plurality of first through-holes 113 and the plurality of second through-holes 114 may be disposed in a non-aligned configuration, e.g., alternately disposed, in the first direction (e.g., the Z direction, thereby blocking upper ends of the plurality of first through-holes 113 by the first cathode active material layer 111. The second cathode active material layer structure 120 may include a third cathode active material layer 121 and a fourth cathode active material layer 122 disposed on the third cathode active material layer 121 and in the above-described direction, the third cathode active material layer 121 may include one or more third through-holes 123 extending in the above-described direction, the fourth cathode active material layer 122 may include one or more fourth through-holes 124 extending in the above-described direction, and the third through-holes 123 and the fourth through-holes 124 may be disposed to be aligned in the first direction (Z direction), thereby forming one or more channels 14a and 14b. The third cathode active material layer structure 130 may include a fifth cathode active material layer 131 and a sixth cathode active material layer 132 disposed to be stacked on the fifth cathode active material layer 131 in the above-described direction, the fifth cathode active material layer 131 may include one or more fifth through-holes 133 extending in the above-described direction, the sixth cathode active material layer 132 may include one or more sixth through-holes 134 extending in the above-described direction, and the fifth through-holes 133 and the sixth through-holes 134 may be disposed to be aligned) in the first direction (Z direction), thereby forming one or more channels 14a and 14b. Accordingly, the cathode active material layer 12 has a channel structure 14 extending in the direction from one surface 12a to the other surface 12b, and the channel structure 14 extends to the second cathode active material layer 112. Since the channel structure 14 is separated from the cathode current collector 11 by the first cathode active material layer 111, localized lithium precipitation can be prevented, for example, due to excessive current density on the surface of a current collector.

Referring to FIGS. 11 to 14, one or more first, third, and fifth through-holes 113, 123, and 133 included in the first, third, and fifth cathode active material layers 111, 121, and 131 may be disposed to be spaced apart from each other along a surface perpendicular to the thickness direction of the first cathode active material layer. A first pitch P1, at which the one or more first, third, and fifth through-holes 113, 123, and 133 are spaced apart from each other, may be selected according to the battery energy density and/or discharge capacity desired. One or more second, fourth, and sixth through-holes 114, 124, and 134 included in the second, fourth, and sixth cathode active material layers 112, 122, and 132 may be disposed to be spaced apart from each other along a surface perpendicular to the thickness direction of the second cathode active material layer. A second pitch P2, at which the one or more second, fourth, and sixth through-holes 114, 124, and 134 are spaced apart from each other, may be selected according to the battery energy density and/or discharge capacity desired.

The first pitch P1, at which the one or more first, third, and fifth through-holes 113, 123, and 133 are spaced apart from each other, and the second pitch P2, at which the one or more second, fourth, and sixth through-holes 114, 124, and 134 are spaced apart from each other, may be each independently, for example, about 50 μm—to about 1000 μm, about 50 μm—to about 750 μm, about 50 μm —to about 500 μm, or about 50 μm—to about 250 μm. Although not shown, the first pitch P1, at which the one or more first, third, and fifth through-holes 113, 123, and 133 are spaced apart from each other, may be different from the second pitch P2, at which the one or more second, fourth, and sixth through-holes 114, 124, and 134 are spaced apart from each other. The first pitch may be about 10% to about 95%, about 10% to about 90%, about 10% to about 80%, or about 15% to about 80% of the second pitch.

A first diameter D1 of each of the one or more first, third, or fifth through-holes 113, 123, and 133, and a second diameter D2 of each of the one or more second, fourth, or sixth through-holes 114, 124, and 134 are each independently, for example, about 0.5 μm—to about 300 μm, about 10 μm—to about 300 μm, about 10 μm—to about 200 μm, about 10 μm—to about 100 μm, or about 10 μm—to about 60 μm.

Referring to FIG. 15, each of one or more cathode active material layer structures 110, 120, and 130 may include first, third, or fifth cathode active material layers 111, 121, and 131 and second, fourth, or sixth cathode active material layers 112, 122, and 132 disposed to be stacked on the first, third, or fifth cathode active material layers 111, 121, and 131, respectively, and the first diameter D1 of each of the one or more first, third, or fifth through holes 113, 123, and 133 in the first cathode active material layers 111, 121, and 131 may be different from the second diameter D2 of each of the one or more second, fourth, or sixth through-holes 114, 124, and 134 included in the second, fourth, or sixth cathode active material layers 112, 122, and 132. The first diameter D1 may be about 10% to about 95%, about 10% to about 90%, about 10% to about 80%, or about 15% to about 80% of the second diameter D2.

Referring to FIG. 16, one or more cathode active material layer structures 110, 120, and 130 include first, third, and fifth cathode active material layers 111, 121, and 131 and second, fourth, and sixth cathode active material layers 112, 122, and 132 disposed to be stacked on the first, third, and fifth cathode active material layers 111, 121, and 131, respectively, in the thickness direction, and a first thickness Ta of each of the first, third, and fifth cathode active material layers 111, 121, and 131 may be different from a second thickness Tb of each of the second, fourth, and sixth cathode active material layers 112, 122, and 132. The first thickness Ta may be greater than the second thickness Tb. The second thickness Tb is about 1% to about 95%, about 5% to about 90%, or about 10% to about 80% of the first thickness Ta. The first thickness Ta is, for example, about 5 μm to about 100 μm, and the second thickness Tb is, for example, about 1 μm to about 20 μm.

Referring to FIG. 17, the cathode 10 may include a cathode current collector 11 and a cathode active material layer 12 disposed on the cathode current collector 11, the cathode active material layer 12 may include one or more first, second, and third cathode active material layer structures 110, 120, and 130 disposed in the thickness direction, and may further include an uppermost cathode active material layer 141 disposed on one or more of the uppermost surfaces as shown in FIG. 17, or lowermost surface (not shown), of the one or more first, second, and third cathode active material layer structures 110, 120, and 130, the one or more first, second, and third cathode active material layer structures 110, 120, and 130 may include first, third, and fifth cathode active material layers 111, 121, and 131 and second, fourth, and sixth cathode active material layers 112, 122, and 132 disposed on the first, third, and fifth cathode active material layers 111, 121, and 131, respectively, in the first direction (e.g., the thickness direction), the first, third, and fifth cathode active material layers 111, 121, and 131 may include a plurality of first, third, and fifth through-holes 113, 123, and 133 extending in the first direction (e.g., the thickness direction), and the plurality of second, fourth, and sixth cathode active material layers 112, 122, and 132 may include a plurality of second, fourth, and sixth through-holes 114, 124, and 134 extending, for example, in the thickness direction, the uppermost cathode active material layer 141 may include a plurality of third through-holes 143 extending in the first direction (e.g., the thickness direction), two or more of the first, third, and fifth through-holes 113, 123, and 133, the second, fourth, and sixth through-holes 114, 124, and 134, and the third through-holes 143, may be disposed to be in line (e.g., aligned) in the thickness direction. For example, by further including the uppermost cathode active material layer 141 disposed on the uppermost surface of the one or more first, second, and third cathode active material layer structures 110, 120, and 130 and by the uppermost cathode active material layer 141 having a high dopant concentration, deterioration of the cathode active material layer 12 can be more effectively prevented on one surface 12a of the cathode active material layer, opposite to an anode (not shown), and a region adjacent thereto. For example, by further including the uppermost cathode active material layer 141 disposed on the lowermost surface of the one or more first, second, and third cathode active material layer structures 110, 120, and 130 and the uppermost cathode active material layer 141 having a high dopant concentration, an increase in internal resistance can be more effectively prevented on the second surface 12b of the cathode active material layer in contact with the cathode current collector 11 and a region adjacent thereto. In addition, since the first, third, and fifth through-holes 113, 123, and 133, the second, fourth, and sixth through-holes 114, 124, and 134, the uppermost through-hole 143, or a combination thereof, are disposed to be aligned along the thickness direction, the high-rate characteristics of the battery including the cathode 10 can be further improved.

Referring to FIG. 18, the cathode 10 includes a cathode current collector 11 and a cathode active material layer 12 disposed on the cathode current collector 11, the cathode active material layer 12 includes one or more first, second, and third cathode active material layer structures 110, 120, and 130 that are disposed to be stacked in the thickness direction, and further includes the one or more first, second, and third cathode active material layer structures 110, 120, and 130 may include first, third, and fifth cathode active material layers 111, 121, and 131 and second, fourth, and sixth cathode active material layers 112, 122, and 132 disposed to be stacked on the first cathode active material layers 111, 121, and 131, respectively, in the thickness direction, the first, third, and fifth cathode active material layers 111, 121, and 131 may include a plurality of first, third, and fifth through-holes 113, 123, and 133 extending in the first direction, and the plurality of second, fourth, and sixth cathode active materials 112, 122, and 132 may include a plurality of second, fourth, and sixth through-holes 114, 124, and 134 extending, for example, in the thickness direction, the uppermost cathode active material layer 141 may include a plurality of uppermost through-holes 143 extending in the first direction, and two or more of the first, third, fifth through-holes 113, 123, and 133, the second, fourth, and sixth through-holes 114, 124, and 134, and the uppermost through-holes 143, may be disposed in a non-aligned configuration (e.g., alternately disposed) in the thickness direction.

Referring to FIGS. 11 to 16, when one or more first, third, and fifth cathode active material layers 111, 121, and 131, and one or more second, fourth, and sixth cathode active material layers 112, 122, and 132 are prepared through a sintering process, a porous structure may be prepared. A liquid electrolyte (not shown), which will be described later, may be filled in pores included in the first, third, and fifth cathode active material layers 111, 121, and 131, and the one or more second, fourth, and sixth cathode active material layers 112, 122, and 132. In this case, the porous structure, which includes the first, third, and fifth cathode active material layers 111, 121, and 131, and the second, fourth, and sixth cathode active material layers 112, 122, and 132, may act as a conduction channel of a metal ion. Although not shown, the cathode 10 may include a cathode current collector 11 and a cathode active material layer 12 disposed on the cathode current collector 11, the cathode active material layer 12 may include one or more first, second, and third cathode active material layer structures 110, 120, and 130, and may further include an uppermost cathode active material layer 141 disposed on one or more of the uppermost or lowermost surfaces of the one or more first, second, and third cathode active material layer structures 110, 120, and 130.

Referring to FIGS. 17 and 18, the cathode 10 may include a cathode current collector 11 and a cathode active material layer 12 disposed on the cathode current collector 11, the cathode active material layer 12 may include one or more first, second, and third cathode active material layer structures 110, 120, and 130, and may further include an uppermost cathode active material layer 141 disposed on one or more of the uppermost surface or lowermost surface of the one or more first, second, and third cathode active material layer structures 110, 120, and 130, the one or more first, second, and third cathode active material layer structures 110, 120, and 130, may include first, third, and fifth cathode active material layers 111, 121, and 131, and second, fourth, and sixth cathode active material layers 112, 122, and 132, disposed to be stacked on the first, third, and fifth cathode active material layers 111, 121, and 131, in the above-described direction, respectively, the first, third, and fifth cathode active material layers 111, 121, and 131, may have a first porosity, and the second, fourth, and sixth cathode active material layers 112, 122, and 132, may have a second porosity, and the uppermost cathode active material layer 141 may have a third porosity, and the first porosity and the third porosity may be less than the second porosity.

The second porosity may be about 20% to about 60%, and the first porosity and the third porosity may be about 1% to about 10%. By having the second porosity, which is relatively high, the second, fourth, and sixth cathode active material layers 112, 122, and 132 may provide a conduction path of a metal ion between the second, fourth, and sixth cathode active material layers 112, 122, and 132, and the first, third, and fifth cathode active material layers 111, 121, and 131 disposed adjacent thereto. The first porosity, the second porosity, and the third porosity are porosities of the first, third, and fifth cathode active material layers 111, 121, and 131, the second, fourth, and sixth cathode active material layers 112, 122, and 132, and the uppermost cathode active material layer 141, respectively. The porosities and pore volumes can be measured by, for example, nitrogen adsorption. The volume of the through-holes may be derived by measuring the diameter and depth of the through-hole through, for example, an SEM image.

A volume ratio (HV/PV) of a volume (HV) of through-holes included in the second, fourth, and sixth cathode active material layers 112, 122, and 132 having the second porosity to a volume (PV) of pores included in the second, fourth, and sixth cathode active material layers 112, 122, and 132, is, for example, about 0.2—to about 10, about 0.2—to about 7, about 0.2—to about 5, or about 0.2—to about 3. As the ratio (HV/PV) increases, the high-rate characteristic of the battery may be improved. The second, fourth, and sixth cathode active material layers 112, 122, and 132 may include, for example, about 55 volume percent (vol %) of the cathode active material, based on a total volume of each cathode active material layer.

A volume ratio (HV/PV) of a volume (HV) of through-holes included in the first, third, and fifth cathode active material layers 111, 121, and 131 having the first porosity to a volume (PV) of pores included in the first, third, and fifth cathode active material layers 111, 121, and 131, is, for example, about 1 to about 100, about 2 to about 50, or about 2 to about 30. As the ratio (HV/PV) increases, the high-rate characteristic of the battery may be improved. The first, third, and fifth cathode active material layers 111, 121, and 131, and the uppermost cathode active material layer 141 may each include, for example, about 95 vol % of the cathode active material, respectively, based on a total volume of each cathode active material layer.

Referring to FIGS. 17 and 18, the cathode active material layer 12 may include, for example, a first cathode active material layer structure 110, a second cathode active material layer structure 120, and a third cathode active material layer structure 130, and may further include an uppermost cathode active material layer 141 disposed on the uppermost surface of the cathode active material layer structure 130.

The first cathode active material layer structure 110 may include a firs cathode active material layer 111 and a second cathode active material layer 112 disposed to be stacked on the first cathode active material layer 111 in the above-described direction, the first cathode active material layer 111 may have a first porosity, the second cathode active material layer 112 may have a second porosity, the first porosity may be about 1% to about 5%, and the second porosity may be about 20% to about 60%, each based on a total volume of each respective cathode active material layer.

The second cathode active material layer structure 120 may include a third cathode active material layer 121 and a fourth cathode active material layer 122 disposed to be stacked on the third cathode active material layer 121 in the above-described direction, the third cathode active material layer 121 may have a first porosity, the fourth cathode active material layer 122 may have a second porosity, the first porosity may be about 1% to about 5%, and the second porosity may be about 20% to about 60%, each based on a total volume of each respective cathode active material layer.

The third cathode active material layer structure 130 may include a fifth cathode active material layer 131 and a sixth cathode active material layer 132 disposed to be stacked on the fifth cathode active material layer 131 in the above-described direction, the fifth cathode active material layer 131 may have a first porosity, the sixth cathode active material layer 132 may have a second porosity, the first porosity may be about 1% to about 5%, and the second porosity may be about 20% to about 60%, each based on a total volume of each respective cathode active material layer.

The third-third cathode active material layer 141 may have a third-third porosity, and the third-third porosity may be about 1% to about 5%.

Referring to FIGS. 17 and 18, the cathode 10 may include a cathode current collector 11 and a cathode active material layer 12 disposed on the cathode current collector 11, the cathode active material layer 12 may include one or more first, second, and third cathode active material layer structures 110, 120, and 130, and may further include an uppermost cathode active material layer 141 disposed on one or more of the uppermost surface or the lowermost surface of the one or more first, second, and third cathode active material layer structures 110, 120, and 130, the one or more first, second, and third cathode active material layer structures 110, 120, and 130 may include first, third, and fifth cathode active material layers 111, 121, and 131, and second, fourth, and sixth cathode active material layers 112, 122, and 132 disposed to be stacked on the first, third, and fifth cathode active material layers 111, 121, and 131 in the above-described direction, respectively, the first, third, and fifth cathode active material layers 111, 121, and 131, may have a first thickness, and the second, fourth, and sixth cathode active material layers 112, 122, and 132, may have a second thickness, and the uppermost cathode active material layer 141 may have an uppermost thickness, and the first thickness and the uppermost thickness may be greater than the second thickness.

The second thickness may be about 1% to about 95%, about 5% to about 90%, or about 10% to about 80% of the first thickness and the uppermost thickness. The first thickness and the uppermost thickness are, for example, about 5 μm to about 100 μm, and the second thickness is, for example, about 1 μm to about 20 μm.

Since the second, fourth, and sixth cathode active material layers 112, 122, and 132 having a high porosity have a reduced thickness, the energy density of the cathode 10 may be improved.

Referring to FIGS. 11 to 18, the first, third, and sixth cathode active material layers 111, 121, and 131, and the second, fourth, and sixth cathode active material layers 112, 122, and 132, may be, for example, sintered layers prepared through a sintering process, respectively. The sintered layers may provide an increased density compared to a mixture layer including cathode active material particles. Accordingly, the energy density of a battery employing the cathode 10, which includes the first, third, and fifth cathode active material layers 111, 121, and 131, and the second, fourth, and sixth cathode active material layers 112, 122, and 132, may be increased.

The sintered cathode active material layer 12, which includes the first, third, and fifth cathode active material layers 111, 121, and 131, and the second, fourth, and sixth cathode active material layers 112, 122, and 132, may include a plurality of crystallites, and the plurality of crystallites may be oriented in the first direction. Major axes of the plurality of crystallites may be arranged, for example, in the channel direction. The major axes of the plurality of crystallites may be arranged, for example, in the second direction (X direction) or third direction (Y direction), to then be arranged in the surface direction of the channels 14a and 14b.

The first, third, and fifth cathode active material layers 111, 121, and 131, and the second, fourth, and sixth cathode active material layers 112, 122, and 132, may be binder-free layers because the binder is removed by heat treatment during the sintering process. Since the first, third, and fifth cathode active material layers 111, 121, and 131, and the second, fourth, and sixth cathode active material layers 112, 122, and 132, do not contain a binder, the energy density of the cathode active material layer 12 may be improved. The cathode active material layer 12 may be a sintered layer, which is a binder-free layer.

Referring to FIGS. 12 to 16, with respect to the total area of the first surface 12a of the cathode active material layer, e.g., measured along the surface perpendicular to the thickness direction (Z direction) of the cathode active material layer, the area occupied by a plurality of through-holes is, for example, about 1% to about 15%, about 1% to about 10%, or about 1% to about 5%. If the area occupied by the plurality of through-holes is excessively increased, the energy density of the battery is decreased. If the area occupied by the plurality of through-holes is excessively reduced, the effect exerted by introducing channels may be difficult to be expressed.

In addition, the cathode active material layer 12 may be a conductive-material-free layer that does not include a conductive material. Alternatively, although not shown, the cathode active material layer 12 may further include a conductive material. The conductive material may be, for example, a metal-based conductive material. The metal-based conductive material may be Al, Cu, Ni, Co, Cr, W, Mo, Ag, Au, Pt, Pb, or a combination thereof.

Referring to FIGS. 11 a to 18, the first, third, and fifth cathode active material layers 111, 121, and 131, and the second, fourth, and sixth cathode active material layers 112, 122, and 132, may include different cathode active materials. For example, the first, third, and fifth cathode active material layers 111, 121, and 131, may include a first cathode active material of Chemical Formulas 1 to 4, or a combination thereof, and the second, fourth, and sixth cathode active material layers 112, 122, and 132, may include a different cathode active material, such as a cathode active material of Chemical Formulas 5 to 8, or a combination thereof. For example, a first cathode active material layer 111, a third cathode active material layer 121, and a fifth cathode active material layer 131, may include different cathode active materials of chemical formulas 1 to 4. For example, a second cathode active material layer 112, a fourth cathode active material layer 122, and a sixth cathode active material layer 132, may include different cathode active materials of chemical formulas 5 to 8.

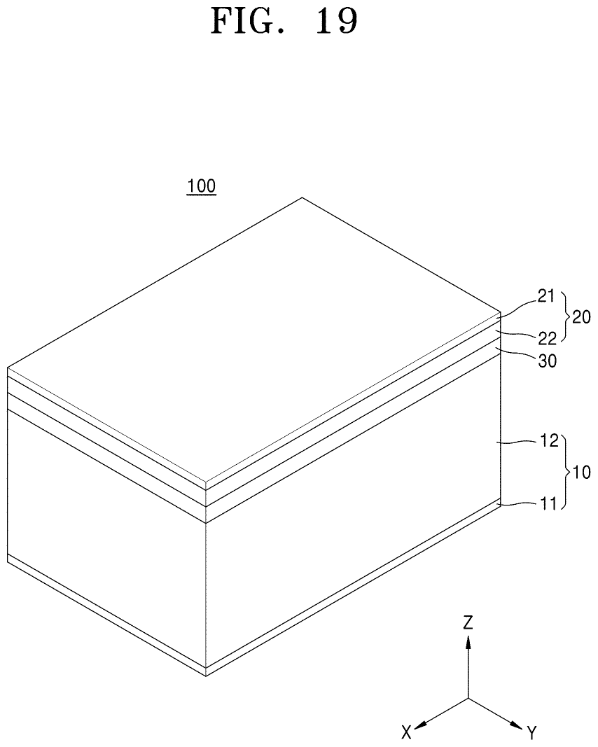

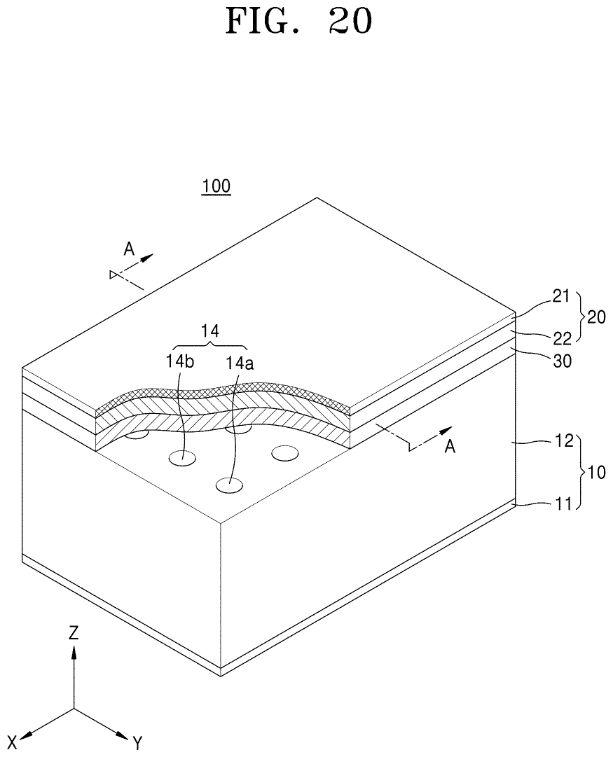

FIG. 19 is a perspective view of an embodiment schematically showing a structure of the electrochemical cell 100; FIG. 20 is a partial cross-sectional view partially showing the inside of the electrochemical cell 100 of FIG. 19, showing cathode active material layer structures of FIGS. 11A and 11B;

Referring to FIGS. 19 and 20, the electrochemical cell 100 includes: the cathode 10; an anode 20, a separator 30 disposed between the cathode and the anode; and a liquid electrolyte in the separator 30.

The electrochemical cell 100 may provide improved cycle characteristics by including the above-described cathode having improved stability. The separator 30 prevents a short circuit by blocking contact between the cathode 10 and the anode 20. In addition, the separator 30 impregnated with the liquid electrolyte ionically conducts, and electronically blocks the cathode 10 and the anode 20.

The electrochemical cell 100 is, for example, a lithium battery and is manufactured by the following example method, but is not limited to this method and may be modified according to desired conditions.

The cathode 10 is prepared according to a method of manufacturing a cathode to be described later.

The anode 20 is prepared as follows. For example, an anode active material composition is prepared by mixing an anode active material, a conductive agent, a binder, and a solvent. The anode 20 having an anode active material layer 22 disposed on an anode current collector 21 is prepared by directly coating the anode active material composition on the anode current collector 21, and drying. Alternatively, the anode 20 is prepared by casting the prepared anode active material composition on a separator support, disposing a film of the anode active material layer 22 peeled off from the support, and laminating.

The anode current collector 21 may comprise a conductive metal such as Cu, Au, Pt, Ag, Zn, Al, Mg, Ti, Fe, Co, Ni, Ge, In, Pd, stainless steel, or a combination thereof, but is not necessarily limited thereto, and any suitable conductive metal can be used, e.g., a metal used as an anode current collector 21 in the art. For example, the anode current collector 21 is a copper (Cu) foil.

The anode active material is not particularly limited, and any suitable metal or metal alloy used as an anode active material in the art can be used. The anode active material is, for example, an alkali metal (e.g., lithium, sodium, potassium), an alkaline earth metal (e.g., calcium, magnesium, barium) and/or a transition metal (e.g., zinc), or an alloy thereof. The anode active material is, for example, lithium metal, a metal alloyable with lithium, a transition metal oxide, a non-transition metal oxide, a carbon-based material, or a combination thereof. The anode active material is, for example, a lithium metal. When a lithium metal is used as the anode active material, a current collector may be omitted or may not be omitted. When the current collector is omitted, the volume and weight occupied by the current collector are reduced, and thus the energy density per unit weight of the lithium battery is improved. The anode active material is, for example, an alloy of a lithium metal and another anode active material. Another anode active material is, for example, a metal alloyable with lithium. The metal alloyable with lithium is, for example, Si, Sn, Al, Ge, Pb, Bi, Sb Si—Y′ alloy (Y′ is an alkali metal, an alkaline earth metal, a Group 13 element, a Group 14 element, a transition metal, a rare earth element, or a combination thereof, not being Si), Sn—Y′ alloy (Y′ is an alkali metal, an alkaline earth metal, a Group 13 element, a Group 14 element, a transition metal, a rare earth element, or a combination thereof, not being Sn). The element Y′ is, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof. The lithium alloy is, for example, a lithium-aluminum alloy, a lithium-silicon alloy, a lithium-tin alloy, a lithium-silver alloy, a lithium-lead alloy. The anode active material is, for example, a transition metal oxide. The transition metal oxide is, for example, lithium titanium oxide, vanadium oxide, lithium vanadium oxide. The anode active material is, for example, a non-transition metal oxide. The non-transition metal oxide is, for example, SnO₂, SiOₓ (0<x<2). The anode active material is, for example, a carbon-based material. The carbon-based material is, for example, crystalline carbon, amorphous carbon, or a mixture thereof. The crystalline carbon is, for example, graphite, such as natural or artificial graphite, in a shapeless, plate-shaped, flake-shaped, spherical or fiber form. The amorphous carbon is, for example, soft carbon or hard carbon, mesophase pitch carbide, sintered cokes.

The contents of the anode active material, the conductive agent, the binder, and the solvent are at levels commonly used in a lithium battery. One or more of the conductive material, the binder, and the solvent may be omitted according to the use and configuration of the lithium battery.

The content of the binder included in the anode is, for example, about 0.1 weight percent (wt %) to about 10 wt %, or about 0.1 wt % to about 5 wt % of the total weight of the anode active material layer. The content of the conductive agent included in the anode is, for example, about 0.1 wt % to about 10 wt %, or about 0.1 wt % to about 5 wt % of the total weight of the anode active material layer. The content of the anode active material included in the anode is, for example, about 90 wt % to about 99 wt %, or about 95 wt % to about 99 wt % of the total weight of the anode active material layer. When the anode active material is a lithium metal, the anode may not include a binder and a conductive agent.

Next, a separator 30 to be inserted between the cathode 10 and the anode 20 is prepared.

The separator 30 may be any suitable material used in an electrochemical cell. A separator having excellent electrolyte-impregnating capability while having a low resistance to ion movement of the electrolyte, is used as the separator 30. The separator 30 is, for example, glass fiber, polyester, Teflon, polyethylene, polypropylene, polytetrafluoroethylene (PTFE), or a combination thereof, and is in the form of a nonwoven or woven fabric. A windable separator comprising, for example, polyethylene, polypropylene, is used in an electrochemical cell.

The separator may be manufactured by the following method, but is not necessarily limited to this method and is adjusted as desired.

First, a separator composition is prepared by mixing a polymer resin, a filler, and a solvent. The separator composition is directly coated on the electrode and dried to form a separator. Alternatively, the separator composition is cast and dried on a support, a separator film peeled off from the support is laminated on an electrode to form a separator. The polymer used for manufacturing the separator is not particularly limited, and any polymer used for the binder of the electrode plate may be used. For example, vinylidene fluoride/hexafluoropropylene copolymer, polyvinylidene fluoride (PVDF), polyacrylonitrile, polymethyl methacrylate, or mixtures thereof, or the like, may be used.

In an aspect, a solid state electrolyte may be used to separate the cathode and the anode to provide an electrochemical cell comprising the cathode; an anode; and the solid-state electrolyte between the cathode and the anode. The solid electrolyte may be an inorganic solid electrolyte, and may comprises an oxide solid electrolyte or a sulfide-containing solid electrolyte, or a combination thereof. Examples of the oxide solid electrolyte include Li_{1+x+y}AlₓTi₂₋ₓSi_{y}P_{3-y}O₁₂ (where 0<x<2 and 0≤y<3), BaTiO₃, Pb(ZrₐTi₁₋ₐ)O₃ (PZT) (where 0≤a≤1), Pb₁₋ₓLaₓZr_{1-y} Ti_{y}O₃ (PLZT) (where 0≤x<1 and 0≤y<1), Pb(Mg_{1/3}Nb_{2/3}) O₃−PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (where 0≤x≤1, 0≤y≤1, 0≤a≤1, and 0≤b≤1), LiₓLa_{y}TiO₃ (where 0<x<2 and 0<y<3), Li₂O, LiOH, Li₂CO₃, LiAlO₂, Li₂O—Al₂O₃—SiO₂—P₂O₅—TiO₂—GeO₂, or Li₃₊ₓLa₃M₂O₁₂ (where M is Te, Nb, or Zr, and 0≤x≤10). Examples of the sulfide solid electrolyte include Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCI, Li₂S—SiS₂—B₂S₃—LiI, Li₂S—SiS₂—P₂S₅—LiI, Li₂S—B₂S₃, Li₂S—P₂S₅—ZₘSₙ (where m and n each are a positive number, Z represents any of Ge, Zn, and Ga), Li₂S—GeS₂, Li₂S—SiS₂—Li₃PO₄, Li₂S—SiS₂—LiₚMO_{q} (where p and q each are a positive number, M represents at least one of P, Si, Ge, B, Al, Ga, or In), Li₇₋ₓPS₆₋ₓClₓ (where 0≤x≤2), Li₇₋ₓPS₆₋ₓBrₓ (where 0≤x≤2), or Li₇₋ₓPS₆₋ₓIₓ (where 0≤x≤2). A combination comprising at least one of the foregoing may be used. The solid state electrolyte may be deposited in the form of an electrolyte layer on the cathode, anode, or both, by sputtering, for example. In an aspect, the solid state electrolyte is deposited on the anode.

Next, a liquid electrolyte is prepared.

The liquid electrolyte is, for example, an anhydrous electrolyte. The liquid electrolyte is, for example, an organic electrolyte. The organic electrolyte is prepared, for example, by dissolving a lithium salt in an organic solvent.

Any suitable organic solvent may be used, e.g., a solvent used as an organic solvent in the art. Examples of the organic solvent may include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or mixtures thereof.

Any suitable lithium salt may be used, e.g., a lithium salt used in the art. Examples of the lithium salt may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂), (where x and y are each from 1 to 20), LiCl, LiI, or mixtures thereof. The concentration of the lithium salt contained in the liquid electrolyte is, for example, about 0.1 M to about 10 M, or about 0.1 M to about 5 M.

As shown in FIGS. 11 to 13, the electrochemical cell 100 includes a cathode 10, an anode 20, and a separator 30. The cathode 10, the anode 20, and the separator 30 are stacked, or wound or folded to then be accommodated in a battery case (not shown). The liquid electrolyte is injected into the battery case and sealed to complete the electrochemical cell 100. The battery case has, for example, a square shape, a thin film shape, a cylindrical shape, but not limited thereto.

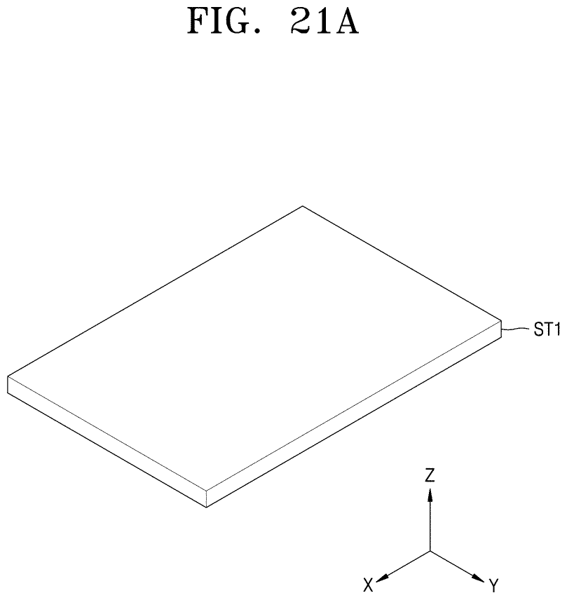

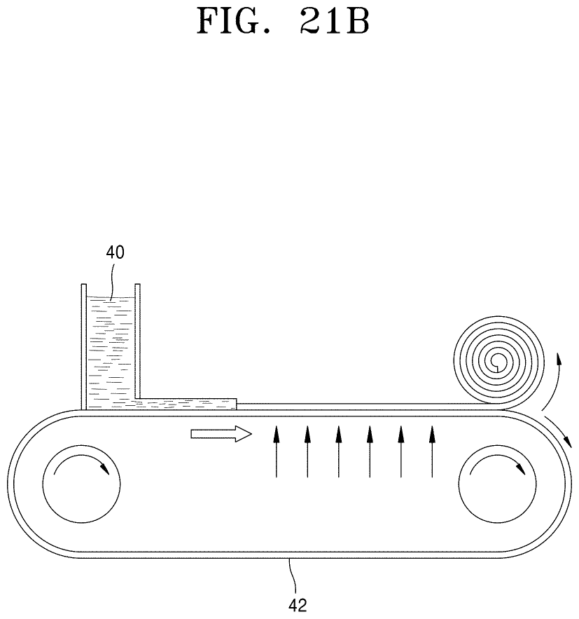

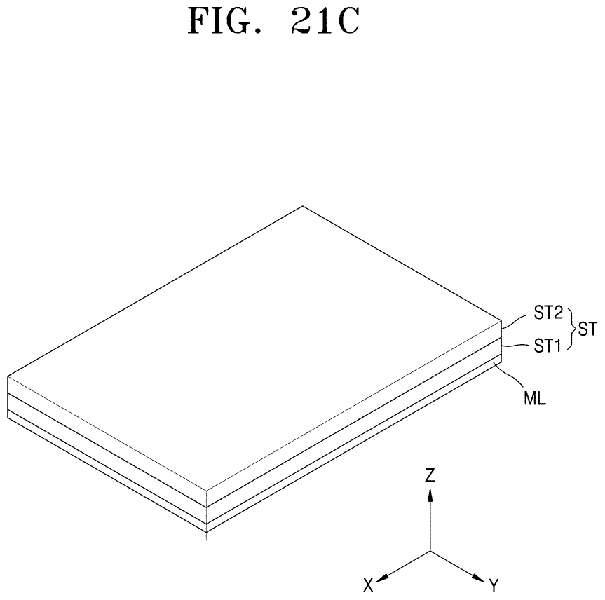

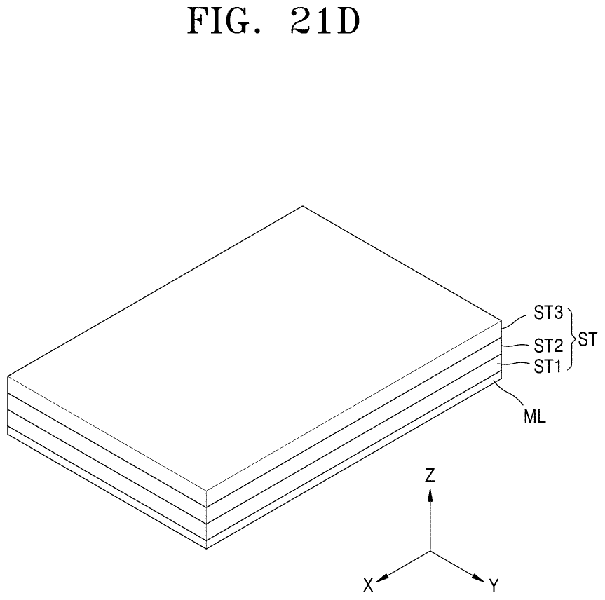

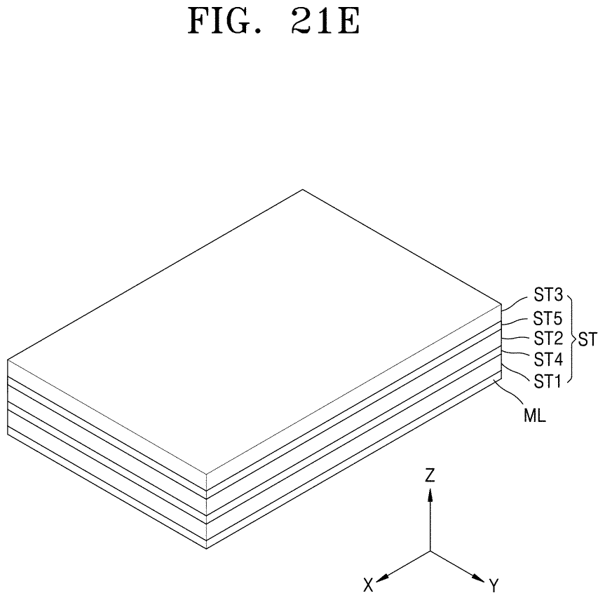

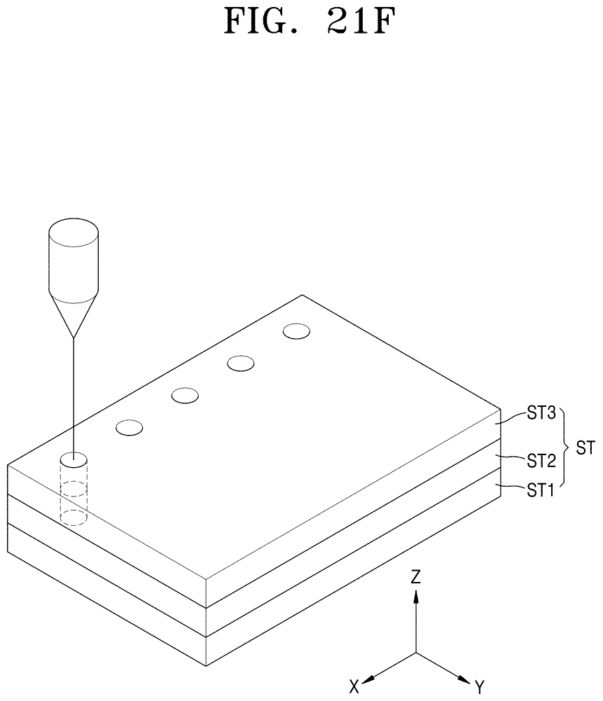

FIGS. 21A to 21F are perspective views for explaining a method for preparing a cathode.

The method for preparing a cathode includes the steps of: providing a first cathode active material sheet including a dopant-free first cathode active material or a first cathode active material having a first dopant concentration; preparing a sheet laminate by disposing a second cathode active material sheet including a second cathode active material having a second dopant concentration on one surface of the first cathode active material sheet; preparing a laminate structure by disposing a conductive metal layer on the other surface of the first cathode active material sheet; and sintering the laminate structure, wherein the first dopant concentration in the first cathode active material is less than the second dopant concentration in the second cathode active material. Therefore, the cathode active material layer has a concentration gradient in which the concentration of the dopant decreases from the first surface to the second surface of the cathode active material layer included in the cathode. Accordingly, the stability of the cathode is improved, and the cycle characteristics of the battery including the cathode are improved.

Referring to FIGS. 21A and 21B, a composition 40 for the first cathode active material is prepared by mixing a cathode active material, a conductive agent, a binder and a solvent. A first cathode active material included in the first cathode active material composition 40 may be a dopant-free cathode active material or may have a first dopant concentration.

As the cathode active material having a first dopant concentration, a cathode active material represented by one of Chemical Formulas 1 to 4 may be used. As the dopant-free cathode active material, a cathode active material represented by one of the Chemical Formulas 5 to 8 may be used.

Alternatively, the dopant-free cathode active material is not particularly limited and can be a commercially available cathode active material in the art. The dopant-free cathode active material is, for example, a compound (a lithiated intercalation compound) that is capable of reversible intercalation and deintercalation of lithium. The cathode active material includes, for example, a lithium transition metal oxide, e.g., lithium cobalt oxide, lithium nickel cobalt manganese oxide, lithium nickel cobalt aluminum oxide, lithium iron phosphate, lithium manganese oxide, or a combination thereof. Specifically, usable examples of the cathode active material may include at least one of lithium cobalt oxide of chemical formula LiCoO₂; lithium nickel oxide of chemical formula LiNiO₂; lithium manganese oxides of chemical formula Li₁₊ₓMn₂₋ₓO₄ (0≤x≤0.33), LiMnO₃, LiMn₂O₃, or LiMnO₂; lithium copper oxide of chemical formula Li₂CuO₂; lithium iron oxide of chemical formula LiFe₃O₄; lithium vanadium oxide of chemical formula LiV₃O₈; copper vanadium oxide of chemical formula Cu₂V₂O₇; vanadium oxide of chemical formula V₂O₅; lithium manganese oxide in which a part of Li of chemical formula LiMn₂O₄ is substituted with an alkaline earth metal ion; a disulfide compound; iron molybdenum oxide of chemical formula Fe₂(MoO₄)₃; or a combination thereof. The cathode active material is, for example, LiCoO₂, LiNiO₂, LiMn₂O₄, or LiFePO₄. Specifically, the dopant-free cathode active material is LiCoO₂.

Usable examples of the conductive agent include carbon black, graphite fine particles, natural graphite, artificial graphite, acetylene black, Ketjen black, or carbon fiber; carbon nanotubes; metal powder or metal fiber or metal tube, such as copper, nickel, aluminum, silver; conductive polymers such as polyphenylene derivatives, but are not limited thereto, and any conductive agent used in the art may be used. The conductive agent may be a metal-based conductive agent. The conductive agent may be omitted.

Usable examples of the binder may include a vinylidene fluoride/hexafluoropropylene copolymer, polyvinylidene fluoride, polyacrylonitrile, polymethylmethacrylate, polytetrafluoroethylene (PTFE), mixtures of the aforementioned polymers; a styrene-butadiene rubber-based polymer. As the solvent, for example, N-methylpyrrolidone (NMP), acetone, water may be used, but not limited thereto, and any solvent used in the art may be used.

The contents of the cathode active material, the conductive agent, the binder and the solvent, which are used in the first cathode active material composition 40, are levels commonly used in an electrochemical cell. One or more of the conductive agent, the binder and the solvent may be omitted according to the use and configuration of an electrochemical cell.

The first cathode active material composition 40 may be applied on a transfer belt 42. For example, the transfer belt 42 may move in a first direction, and the first cathode active material composition 40 may be provided on the moving transfer belt 42. The first cathode active material composition 40 may be applied on the transfer belt 42 to a uniform thickness. For example, a doctor blade (not shown) may uniformly control the thickness of the first cathode active material composition 40 applied on the transfer belt 42.

The first cathode active material composition 40 applied on the transfer belt 42 may be dried to form a first cathode active material sheet ST1 having a large area. For example, the first cathode active material composition 40 may be dried by a heating process. Cathode active material particles may be bonded by a binder in the large-area first cathode active material sheet. The large-area first cathode active material sheet may be cut, thereby forming the large-area first cathode active material sheet ST1 shown in FIG. 21A.

In preparing a second cathode active material sheet ST2, the second cathode active material sheet may be prepared by a tape casting method shown in FIG. 21B in substantially the same manner as in preparing the first cathode active material sheet ST1.

The second cathode active material sheet ST2 includes a second cathode active material. The second cathode active material has a second dopant concentration. The content of the first dopant included in the first cathode active material is less than that of the second dopant.

For example, when the second cathode active material sheet ST2 has the same composition as the first cathode active material sheet ST1, a second cathode active material composition having the same composition as the first cathode active material composition, except for the content of the dopant included in the cathode active material, may be prepared. A second cathode active material composition is prepared by, for example, mixing a second cathode active material, a conductive agent, a binder, and a solvent. The second cathode active material included in the second cathode active material composition may have a different dopant concentration from that of the first cathode active material included in the first cathode active material composition. The composition 40 for the second cathode active material may be applied on the transfer belt 42 and dried to form a second cathode active material sheet having a large area, followed by cutting, thereby forming the second cathode active material sheet ST2 shown in FIG. 21C.

Next, the second cathode active material sheet ST2 is disposed on one surface of the first cathode active material sheet ST1 to prepare a sheet laminate.

Then, a conductive metal layer ML is disposed on the other surface of the first cathode active material sheet ST1 to prepare a laminate structure.

For example, the conductive metal layer ML may have a plate shape, and in this case, it may be referred to as a current collecting plate after sintering. A conductive metal layer 11 may be disposed to face one surface of the sheet laminate, for example.

Next, a cathode is prepared by sintering the prepared laminate structure. The sintering may be performed in an air atmosphere, for example, at about 800° C. to about 1200° C. for about 1 hour to about 48 hours.

For example, the cathode may be formed through a sintering process, thereby implementing the cathode including a binder-free cathode active material layer.

The cathode manufacturing method may further include, before disposing the conductive metal layer on one surface of the sheet laminate structure, disposing a third cathode active material sheet including a third cathode active material having a third dopant concentration on one surface of the second cathode active material sheet, in the laminate sheet including the first cathode active material sheet and the second cathode active material sheet, and the third dopant concentration may be greater than the second dopant concentration.

In preparing a third cathode active material sheet ST3, the third cathode active material sheets may be prepared by the tape casting method shown in FIG. 21B in substantially the same manner as in preparing the first cathode active material sheet ST1.

The third cathode active material sheet ST 3 includes a third cathode active material. The third cathode active material has a third dopant concentration. The content of the third dopant included in the third cathode active material is greater than that of the second dopant.

For example, when the third cathode active material sheet ST3 has the same composition as the first cathode active material sheet ST1, a third cathode active material composition having the same composition as the first cathode active material composition, except for the content of the dopant included in the cathode active material, may be prepared. A third cathode active material composition is prepared by, for example, mixing a third cathode active material, a conductive agent, a binder, and a solvent. The third cathode active material included in the third cathode active material composition may have a different dopant concentration from that of the first cathode active material included in the first cathode active material composition. The composition 40 for the third cathode active material may be applied on the transfer belt 42 and dried to form a third cathode active material sheet having a large area, followed by cutting, thereby forming the third cathode active material sheet ST3 shown in FIG. 21D.

The cathode manufacturing method may further include disposing a fourth cathode active material sheet and a fifth cathode active material sheet between the first cathode active material sheet and the second cathode active material sheet, and between the second cathode active material sheet and the third cathode active material sheet, respectively, wherein the fourth cathode active material sheet and the fifth cathode active material sheet are dopant-free sheets, the sintering products of the fourth cathode active material sheet and the fifth cathode active material sheet may have greater porosities than the sintering products of the first, second and third cathode active material sheets.

In preparing a fourth cathode active material sheet ST4 and a fifth cathode active material sheet ST5, the fourth and fifth cathode active material sheets may be prepared by the tape casting method shown in FIG. 21B in substantially the same manner as in preparing the first cathode active material sheet ST1.

For example, when the fourth and fifth cathode active material sheets ST4 and ST5 have different compositions from the first cathode active material sheet ST1, fourth and fifth cathode active material compositions having different compositions from the first cathode active material composition may be prepared. The fourth and fifth cathode active material compositions are prepared by mixing by mixing a cathode active material, a conductive agent, a binder and a solvent, for example. The fourth cathode active material included in the fourth cathode active material composition and the fifth cathode active material included in the fifth cathode active material composition may be different from the first cathode active material included in the first cathode active material composition in terms of one or more physical properties including composition, or diameter. The composition 40 for the fourth cathode active material may be applied on the transfer belt 42 and dried to form a fourth cathode active material sheet having a large area, which is then cut to form the fourth cathode active material sheet ST4 shown in FIG. 21E. The composition 40 for the fifth cathode active material may be applied on the transfer belt 42 and dried to form a fifth cathode active material sheet having a large area, which is then cut to form the fifth cathode active material sheet ST5 shown in FIG. 21E.

As shown in FIG. 21E, the fourth and fifth cathode active material sheets ST4 and ST5 may be disposed between the first cathode active material sheet ST1 and the second cathode active material sheet ST2 and between the second cathode active material sheet ST2 and the fourth cathode active material sheet ST4, respectively. The fourth cathode active material sheet ST4 and the fifth cathode active material sheet ST5 may not include, for example, a dopant, and may form a sheet laminate. The sintering products of the fourth and fifth cathode active material sheet ST4 and ST5 may have less thicknesses than the sintering products of the first, second and third cathode active material sheets ST1, ST2 and ST3. The sintering products of the fourth cathode active material sheet ST4 and the fifth cathode active material sheet ST5 may have greater porosities than the sintering products of the first, second and third cathode active material sheets ST1, ST2 and ST3.

In the cathode manufacturing method, when a laminate structure including more sheets is intended to be formed, the first, second and third cathode active material sheets ST1, ST2 and ST3 may be further repeatedly stacked in the same manner, and the fifth cathode active material sheet ST4 and the fifth cathode active material sheet ST5 may be further repeatedly disposed therebetween.

The cathode manufacturing method may further include, before disposing the conductive metal layer, introducing through-holes in the laminate structure.

Next, referring to FIG. 21F, a channel structure 14 is provided in a cathode active material sheet laminate ST. The channel structure 14 may be provided by extending from one surface 12a to the other surface 12b of the cathode active material layer, that is, in the first direction (Z direction) or in the thickness direction.

For example, a channel structure may be provided by forming one or more first through-holes extending in the thickness direction of the first cathode active material sheet ST1 and one or more second through-holes extending in the thickness direction of the second cathode active material sheet ST2.

The one or more first through-holes and the one or more second through-holes may be formed by using a laser drilling process. For example, the tortuosity of the one or more first through-holes and the one or more second through-holes formed by using a laser drilling process may be about 1 to about 1.5. Accordingly, the one or more first through-holes and the one or more second through-holes may form channels extending in a substantially linear shape along the thickness direction, that is, in the first direction (Z direction).

Alternatively, although not shown, before the first cathode active material sheet ST1 and the second cathode active material sheet ST2 are disposed to be stacked along the first direction (Z direction) to form a cathode active material sheet laminate, one or more first through-holes and one or more second through-holes may be formed on the first cathode active material sheet ST1 and the second cathode active material sheet ST2, respectively. By this method, each of the first cathode active material sheet ST1 and the second cathode active material sheet ST2 may include through-holes having various shapes and positions. In addition, a plurality of positive electrode active material sheets may have different through-hole positions, and sizes.

The present invention will be described in more detail through the following examples and comparative examples. However, these examples are provided to illustrate the present invention, and the scope of the present invention is not limited thereto.

### EXAMPLES

### Manufacture of Cathode and Lithium Battery

Example 1: First sheet (0 mol % doping, dense)/fourth sheet (0 mol % doping, porous)/second sheet (0.15 mol % doping, dense)/fourth sheet (0 mol % doping, porous)/third sheet (0.3 mol % doping, dense) structure with through-hole installed

### Manufacture of Cathode

A first cathode active material sheet having a thickness of 20 μm was prepared by applying a slurry on a transfer belt by using the tape casting method and then forming the slurry in the form of a sheet, followed by drying at 200° C., the slurry including LiCoO₂ powder having an average particle diameter D50 of about 0.3 μm as a first cathode active material, polyvinyl butyral as a binder, dibutylphthalate as a plasticizer, an ester-based surfactant as a dispersant, and a mixed solvent of toluene and ethanol being under azeotropic conditions as a solvent, in a predetermined ratio. The content of LiCoO₂ included in the first cathode active material sheet was 95 vol %, based on a total volume of the sheet.

A second cathode active material sheet having a thickness of 20 μm was prepared in substantially the same manner as the first cathode active material sheet, except that LiCo_{0.9985}Ti_{0.0005}Mg_{0.0005}Al_{0.0005}O₂ powder having an average particle diameter D50 of about 1 μm and doped with 0.15 mol % of Ti, Mg, and Al was used as a second cathode active material. Ti, Mg, and Al as dopants were homogeneously distributed in the cathode active material particles. The Ti:Mg:Al molar ratio was 1:1:1.

A third cathode active material sheet having a thickness of 20 μm was prepared in substantially the same manner as the first cathode active material sheet, except that LiCo_{0.997}Ti_{0.001}Mg_{0.001}Al_{0.001}O₂ powder having an average particle diameter D50 of about 1 μm and doped with 0.3 mol % of Ti, Mg, and Al was used as a third cathode active material. Ti, Mg, and Al as dopants were homogeneously distributed in the cathode active material particles. The Ti:Mg:Al molar ratio was 1:1:1.

A fourth cathode active material sheet having a thickness of 4 μm was prepared by applying a slurry on a transfer belt by using the tape casting method and then forming the slurry in the form of a sheet, followed by drying at 200° C., the slurry including LiCoO₂ powder having an average particle diameter D50 of about 2 μm as a fourth cathode active material, polyvinyl butyral as a binder, dibutylphthalate as a plasticizer, an ester-based surfactant as a dispersant, and a mixed solvent of toluene and ethanol being under azeotropic conditions as a solvent, in a predetermined ratio. The content of LiCoO₂ included in the fourth cathode active material sheet was 55 vol %, based on a total volume of the sheet.

A cathode active material sheet laminate was prepared by disposing the fourth cathode active material sheet on one surface of the first cathode active material sheet, disposing the second cathode active material sheet on the fourth cathode active material sheet, disposing the fourth cathode active material sheet on the second cathode active material sheet, and disposing the third cathode active material sheet on the fourth cathode active material sheet.

A plurality of through-holes which penetrate from one surface to the other surface opposite to the one surface of the cathode active material sheet laminate were formed by laser drilling.

A current collector slurry including an Ag—Pd alloy was coated on the other surface of the cathode active material sheet laminate having the through-holes by using a screen printing method, thereby forming a current collector layer.

A three-dimensional cathode active material layer structure having a channel structure was prepared by aligning the cathode active material sheet laminate having the through-holes on the current collector layer and then sintering at 1025° C. in an air atmosphere for 2 hours.

The thickness of the three-dimensional cathode active material layer structure in the first direction (Z direction) was 68 μm, the length thereof in the second direction (X direction) was 10000 μm, and the length thereof in the third direction (Y direction) was 10000 μm. The diameter of the channel was 30 μm, and the pitch of the channel was 100 μm. One channel includes a plurality of through-holes disposed to be aligned along the first direction (Z direction).

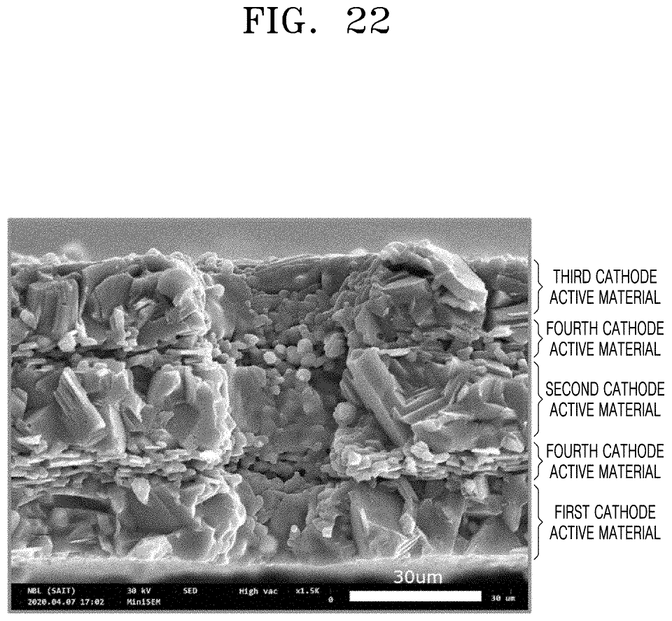

A scanning electron microscope image of a cross-section of the prepared cathode is shown in FIG. 22. The prepared cathode has a similar structure corresponding to, for example, the cathode shown in FIG. 17.

### Manufacture of Lithium Battery

An anode active material slurry was prepared by mixing 98 weight percent (wt %) of artificial graphite (BSG-L, Tianjin BTR New Energy Technology Co., Ltd.), 1.0 wt % of styrene-butadiene rubber (SBR) binder (ZEON) and 1.0 wt % of carboxymethylcellulose (CMC) (NIPPON A&L), based on a total weight of the graphite, SBR and CMC, adding the resultant mixture into distilled water, and stirring by using a mechanical stirrer for 60 minutes. The slurry was applied on a 10 μm thick copper current collector to a thickness of about 60 μm by using a doctor blade, dried in a hot air dryer at 100° C. for 0.5 hours, dried again under vacuum and 120° C. conditions for 4 hours, and rolled (roll press) to prepare an anode.

A lithium battery was manufactured by using the cathode, the anode, a 14 μm thick polyethylene separator coated with ceramic on a cathode side, and a solution containing 1.15 M LiPF 6 dissolved in EC (ethylene carbonate)+EMC (ethyl methyl carbonate)+DMC (dimethyl carbonate) (3:4:3 volume ratio) as an electrolyte.

Example 2: First sheet (0 mol % doping, dense)/fourth sheet (0 mol % doping, porous)/third sheet (0.3 mol % doping, dense)/fourth sheet (0 mol % doping, porous)/third sheet (0.3 mol % doping, dense) structure with through-hole installed

A cathode and a lithium battery were manufactured in the same manner as in Example 1, except that third cathode active material sheets, instead of the second cathode active material sheets, were additionally disposed.

Example 3: Second sheet (0.15 mol % doping, dense)/fourth sheet (0 mol % doping, porous)/second sheet (0.15 mol % doping, dense)/fourth sheet (0 mol % doping, porous)/third sheet (0.3 mol % doping, dense) structure with through-hole installed

A cathode and a lithium battery were manufactured in the same manner as in Example 1, except that second cathode active material sheets, instead of the first cathode active material sheets, were additionally disposed.

Example 4: First sheet (0 mol % doping, dense)/fourth sheet (0 mol % doping, porous)/first sheet (0 mol % doping, dense)/fourth sheet (0 mol % doping, porous)/third sheet (0.3 mol % doping, dense) structure with through-hole installed

A cathode and a lithium battery were manufactured in the same manner as in Example 1, except that first cathode active material sheets, instead of the second cathode active material sheets, were additionally disposed.

Comparative Example 1: First sheet (0.0 mol % doping, dense)/fourth sheet (0 mol % doping, porous)/first sheet (0.0 mol % doping, dense)/fourth sheet (0 mol % doping, porous)/first sheet (0.0 mol % doping, dense) structure with through-hole installed

A cathode and a lithium battery were manufactured in the same manner as in Example 1, except that first cathode active material sheets, instead of the second and third cathode active material sheets, were additionally disposed.

The three-dimensional cathode active material layer structure did not include a dopant.

Comparative Example 2: Second sheet (0.15 mol % doping, dense)/fourth sheet (0 mol % doping, porous)/second sheet (0.15 mol % doping, dense)/fourth sheet (0 mol % doping, porous)/second sheet (0.15 mol % doping, dense) structure without through-hole installed

A cathode and a lithium battery were manufactured in the same manner as in Example 1, except that second cathode active material sheets, instead of the first and third cathode active material sheets, were additionally disposed.

Evaluation Example 1: Evaluation of charging and discharging characteristics

The lithium batteries manufactured in Examples 1 to 3 and Comparative Examples 1 and 2 were charged with a constant current at 25° C. at a current of 0.1 C rate until the voltage reached 4.35 V (vs. Li), and then cut off at a current of 0.01 C rate while maintaining 4.35 V in the constant voltage mode. Then, the lithium batteries were discharged with a constant current of 0.1 C rate until the voltage reached 3 V (vs. Li) during discharge (formation stage 1, 1st cycle). The C rate is a discharge rate of a cell, and is obtained by dividing a total capacity of the cell by a total discharge period of time of 1 hour, e.g., a C rate for a battery having a discharge capacity of 1.6 ampere-hours would be 1.6 amperes.

The lithium batteries having undergone the formation stage were charged with a current of 1 C rate at 25° C. until the voltage reached 4.35 V (vs. Li), and then cut off at a current of 0.1 C rate while maintaining 4.35 V in the constant voltage mode. Then, charging and discharging were performed up to the 330th cycle at a constant current of 1 C rate until the voltage reached 3V (vs. Li) during discharge. However, in the 50th, 100th, 150th, 200th, 250th, and 300th cycles, charging and discharging were performed at a current of 0.2 C rate.

In all the charge/discharge cycles, an idle time of 10 minutes was given after one charge/discharge cycle.

Some of the results of the charging and discharging experiments are shown in Table 1 below. The capacity retention in the 330th cycle is defined by Formula 2:

Capacity retention=[Discharge capacity in 330^{th} cycle/discharge capacity in 1^{st} cycle]×100% Formula 2

TABLE 1

| | Capacity retention [%] in 330^{th} |
|---|---|
| | cycle |
| Example 1 | 83.5 |
| Example 2 | 73.0 |
| Example 3 | 71.4 |
| Example 4 | 68.2 |
| Comparative | 65.5 |
| Example 1 | |
| Comparative | 60.0 |
| Example 2 | |

As shown in Table 1, the lithium batteries of Examples 1 to 4 had improved lifespan characteristics compared to the lithium batteries of Comparative Examples 1 and 2.

According to an aspect, since a cathode has improved stability, deterioration of the cathode adjacent to an anode can be effectively suppressed.

According to another aspect, lifespan characteristics of an electrochemical cell are improved.

It should be understood that embodiments described herein should be considered in a descriptive sense only and not for purposes of limitation. Descriptions of features or aspects within each embodiment should be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode comprising:
a cathode current collector; and
a cathode active material layer disposed on the cathode current collector and comprising
a first surface, and
a second surface opposite the first surface and adjacent to the cathode current collector,
wherein the cathode active material layer comprises a cathode active material comprising a dopant, and
wherein a concentration gradient of the dopant decreases in a direction from the first surface to the second surface.

2. The cathode of claim 1,
wherein the cathode active material layer comprises a plurality of layers, and
wherein the concentration gradient of the dopant is discontinuous or stepwise, and
wherein a dopant concentration of a layer of the plurality of layers of the cathode active material layer adjacent the second surface is less than a dopant concentration of any other layer of the plurality of layers of the cathode active material layer.

3. The cathode of claim 1,
wherein the cathode active material layer comprises a plurality of layers stacked in a thickness direction, and
wherein the plurality of layers comprises a first layer adjacent the cathode current collector and a second layer on a side of the first layer opposite the cathode current collector, and
wherein a dopant concentration of the first layer is different than a dopant concentration of the second layer.

4. The cathode of claim 3,
wherein the layers of the plurality of layers are arranged such that a dopant concentration of the layers of the plurality of layers sequentially decrease in the direction from the first surface towards the second surface.

5. The cathode of claim 3,
wherein the plurality of layers comprises layers L1 to Ln, wherein L1 is adjacent to the current collector and Ln is on a side of the plurality of layers opposite the current collector,
wherein each layer of the plurality of layers has a dopant concentration C1 to Cn corresponding to layers L1 to Ln, respectively, and
wherein the dopant concentrations C1 to Cn satisfy Formula 1:
0≤C(n−1)<Cn Formula 1
wherein n is 2 to 1000.

6. The cathode of claim 5, wherein the dopant concentration of each of C1 to Cn is less than 10 mole percent, based on a total content of each layer.

7. The cathode of claim 1, wherein the dopant comprises a Group 2 to Group 16 elements belonging to the third period to sixth period of the Periodic Table of the Elements, boron, or a combination thereof.

8. The cathode of claim 1,
wherein the dopant comprises titanium, magnesium, aluminum, gallium, silicon, tin, nickel, yttrium, vanadium, zirconium, hafnium, iron, chromium, copper, zinc, molybdenum, tungsten, niobium, manganese, tellurium, barium, antimony, tantalum, germanium, boron, or a combination thereof.

9. The cathode of claim 1, wherein the cathode active material layer is a binder-free layer.

10. The cathode of claim 1, wherein the cathode active material layer comprises a cathode active material, and the cathode active material comprises monocrystalline particles or polycrystalline particles, and the dopant is homogeneously distributed within the monocrystalline particles or the polycrystalline particles.

11. The cathode of claim 1, wherein a density of the cathode active material layer is about 4.0 grams per cubic centimeter to about 4.9 grams per cubic centimeter.

12. The cathode of claim 1,
wherein the cathode active material layer comprises a dopant and a compound represented by Chemical Formulas 1 to 4, or a combination thereof:
LiₐCoₓM_{y}O_{2-α}X_{α} Chemical Formula 1
wherein, in Chemical Formula 1,
1.0≤a≤1.2, 0.9≤x<1, 0<y≤0.1, 0≤a≤0.2, and x+y=1,
M is titanium, magnesium, aluminum, gallium, silicon, tin, nickel, yttrium, vanadium, zirconium, hafnium, iron, chromium, copper, zinc, molybdenum, tungsten, niobium, manganese, tellurium, barium, antimony, tantalum, germanium, boron, or a combination thereof, and
X is F, S, Cl, Br, or a combination thereof;
LiₐNiₓCo_{y}Mn_{z}Al_{w}MᵥO_{2-α}X_{α} Chemical Formula 2
wherein, in Chemical Formula 2,
1.0≤a≤1.2, 0<x<1, 0≤y<1, 0≤z<1, 0≤w<1, 0<v≤0.1, 0≤α≤0.2, and x+y+z+w+v=1,
M is titanium, magnesium, gallium, silicon, tin, yttrium, vanadium, zirconium, hafnium, iron, chromium, copper, zinc, molybdenum, tungsten, niobium, tellurium, barium, antimony, tantalum, germanium, boron, or a combination thereof, and
X is F, S, Cl, Br, or a combination thereof;
LiₐMn₂₋ₓMₓO_{4-α}Xα Chemical Formula 3
wherein, in Chemical Formula 3,
0.9≤a≤1.1, 0<x≤0.1, 0≤α≤0.2,
M is titanium, magnesium, aluminum, gallium, silicon, tin, nickel, yttrium, vanadium, zirconium, hafnium, iron, chromium, copper, zinc, molybdenum, cobalt, tungsten, niobium, tellurium, barium, antimony, tantalum, germanium, boron, or a combination thereof, and
X is F, S, Cl, Br, or a combination thereof; or
LiₐFe_{b}Mn_{c}Co_{d}NiₑMₓPO_{4-α}X_{α} Chemical Formula 4
wherein, in Chemical Formula 4,
0.9≤a≤1.1, 0≤b<1, 0≤c<1, 0≤d<1, 0≤e<1, 0<x≤0.1, b+c+d+e+x=1,
M is titanium, magnesium, aluminum, gallium, silicon, tin, yttrium, vanadium, zirconium, hafnium, chromium, copper, zinc, molybdenum, tungsten, niobium, tellurium, barium, antimony, tantalum, germanium, boron, or a combination thereof, and
X is F, S, Cl, Br, or a combination thereof.

13. The cathode of claim 1, further comprising a channel structure extending from the first surface of the cathode active material layer toward the second surface of the cathode active material layer,
wherein the channel structure comprises a plurality of through-holes extending from the first surface to the second surface of the cathode active material layer.

14. The cathode of claim 1,
wherein the cathode active material layer comprises:
a first domain, which comprises a plurality of layers stacked in a thickness direction; and
a second domain, which comprises one or more layers, wherein each layer of the one or more layers of the second domain is disposed between layers of the plurality of layers of the first domain,
wherein the layers of the plurality of layers of the first domain each have a different dopant concentration, and are disposed to have dopant concentrations sequentially decreasing in a direction from the first surface to the second surface, and
each layer of the second domain has a different dopant concentration than each layer of the first domain.

15. The cathode of claim 14,
wherein a dopant concentration of each layer of the second domain is less than a minimum dopant concentration of each layer of the plurality of layers of the first domain, or
the one or more layers of the second domain is a dopant-free layer.

16. The cathode of claim 14,
wherein a porosity of each layer of the plurality of layers of the first domain is less than a porosity of each layer of the one or more layers of the second domain, or
a thickness of each layer of the plurality of layers of the first domain is greater than a thickness of each of the one or more layers of the second domain.

17. The cathode of claim 14,
wherein the plurality of layers of the first domain, the one or more layers of the second domain, or a combination thereof comprise a plurality of through-holes extending from the first surface to the second surface of the cathode active material layer.

18. The cathode of claim 3,
wherein the cathode active material layer comprises a cathode active material layer structure,
the cathode active material layer structure comprises a first cathode active material layer and a second cathode active material layer,
wherein the second cathode active material layer is disposed on the first cathode active material layer in the thickness direction, and
the first cathode active material layer comprises a plurality of first through-holes extending in a thickness direction.

19. The cathode of claim 18,
wherein the second cathode active material layer comprises a plurality of second through-holes extending in the thickness direction, and
the first through-holes of the first cathode active material layer and the second through-holes of the second cathode active material layer are aligned in the thickness direction.

20. The cathode of claim 18,
wherein the second cathode active material layer comprises a plurality of second through-holes extending in the thickness direction, and
the first through-holes of the first cathode active material layer and the second through-holes of the second cathode active material layer are non-aligned in the thickness direction.

21. The cathode of claim 18, further comprising a third cathode active material layer disposed an uppermost surface, a lowermost surface, or a combination thereof of the cathode active material layer structure,
the second cathode active material layer comprises a plurality of second through-holes extending in the thickness direction,
the third cathode active material layer comprises a plurality of third through-holes extending in the thickness direction, and
two or more of the first through-holes, the second through-holes, the third through-holes, or a combination thereof are aligned in the first direction or are non-aligned in the first direction.

22. The cathode of claim 18, further comprising a third cathode active material layer disposed on an uppermost surface, a lowermost surface, or a combination thereof of the cathode active material layer structure,
wherein the first cathode active material layer has a first porosity, the second cathode active material layer has a second porosity, and the third cathode active material layer has a third porosity,
the first cathode active material layer has a first thickness, the second cathode active material layer has a second thickness, and the third cathode active material layer has a third thickness,
each of the first porosity and the third porosity is less than the second porosity, and
each of the first thickness and the third thickness is greater than the second thickness.

23. The cathode of claim 18,
wherein an area occupied by the plurality of first through-holes is about 1 percent to about 15 percent relative to an area of a surface of the first cathode active material layer, when measured along a surface perpendicular to the thickness direction.

24. The cathode of claim 1, wherein the cathode active material layer is a conductive-agent-free layer.

25. The cathode of claim 18,
wherein the first cathode active material layer comprises a first cathode active material and the second cathode active material layer comprises a second cathode active material, and
wherein a composition of the first cathode active material is different from a composition of the second cathode active material.

26. An electrochemical cell comprising:
the cathode according to claim 1;
an anode;
a separator between the cathode and the anode; and
an electrolyte in a pore of the separator.

27. A method of preparing a cathode, the method comprising:
providing a first cathode active material sheet comprising a dopant-free first cathode active material or a first cathode active material having a first dopant concentration;
disposing on a first surface of the first cathode active material sheet a second cathode active material sheet comprising a second cathode active material having a second dopant concentration;
disposing a conductive metal layer on a second surface of the first cathode active material sheet to provide a laminate structure; and
sintering the laminate structure to prepare the cathode,
wherein the first dopant concentration in the first cathode active material is less than the second dopant concentration in the second cathode active material.

28. The method of claim 27, further comprising, before the disposing the conductive metal layer, disposing on the first surface of the second cathode active material sheet, a third cathode active material sheet comprising a third cathode active material having a third dopant concentration,
wherein the third dopant concentration is greater than the second dopant concentration.

29. The method of claim 27, further comprising disposing a fourth cathode active material sheet and a fifth cathode active material sheet, between the first cathode active material sheet and the second cathode active material sheet and between the second cathode active material sheet and the third cathode active material sheet, respectively,
wherein the fourth cathode active material sheet and the fifth cathode active material sheet are dopant-free, and
a porosity of a sintered fourth cathode active material sheet and a porosity of a sintered fifth cathode active material sheet each have greater porosity than a sintered first cathode active material sheet, a sintered second cathode active material sheet, and a sintered third cathode active material sheet.

30. The method of claim 27, further comprising, before the disposing of a conductive metal layer on a second surface of the first cathode active material sheet to provide a laminate structure,
forming through-holes in the first cathode active material sheet, the second cathode active material sheet, the third cathode active material sheet, or a combination thereof.
